(19) United States
(12) Patent Application Publication
(10) Pub. No.: US 2025/0203400 A1
(43) Pub. Date: Jun. 19, 2025

(54) FEDERATED PARAMETER TRAINING FOR MACHINE LEARNING

(71) Applicant: QUALCOMM Incorporated, San Diego, CA (US)

(72) Inventors: Stelios STEFANATOS, San Diego, CA (US); Arthur GUBESKYS, San Diego, CA (US); Shuanshuan WU, San Diego, CA (US); Libin LIU, Monterey Park, CA (US)

(21) Appl. No.: 18/848,894

(22) PCT Filed: Apr. 6, 2023
(86) PCT No.: PCT/US2023/017775

§ 371 Date: Sep. 19, 2024

(30) Foreign Application Priority Data
May 23, 2022 (GR) 20220100426

(51) Int. Cl. H04W 24/02; G06N 3/084

(52) U.S. Cl. CPC H04W 24/02; G06N 3/084

(57) ABSTRACT

A UE receives parameters of a machine learning model from a network node; calculate a gradient value relative to a parameter of the parameters of the machine learning model, the gradient value including a positive gradient value or a negative gradient value. The UE may transmit, in one resource element (RE) of a pair of REs to the network node, an analog signal indicating a magnitude of the gradient value relative to the parameter of the parameters of the machine learning model. The UE may transmit or skip transmission of, in a single RE to the network node, an analog signal based on the gradient value, the single RE designated for indicating the positive gradient value or the negative gradient value of the gradient value relative to the parameter of the parameters of the machine learning model.

### CROSS-REFERENCE TO RELATED APPLICATION

This application claims the benefit of Greek Patent Application Serial No. 20220100426, entitled “FEDERATED PARAMETER TRAINING FOR MACHINE LEARNING” and filed on May 23, 2022, which is expressly incorporated by reference herein in its entirety.

### TECHNICAL FIELD

The present disclosure relates generally to communication systems, and more particularly, to a method of wireless communication including a federated parameter training.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus receives parameters of a machine learning model from a network node. The apparatus calculates a gradient value relative to a parameter of the parameters of the machine learning model, the gradient value including a positive gradient value or a negative gradient value. The apparatus transmits, in one resource element (RE) of a pair of REs to the network node, an analog signal indicating a magnitude of the gradient value relative to the parameter of the parameters of the machine learning model, the pair of REs designated for indicating the gradient value relative to the parameter of the parameters of the machine learning model.

In an aspect of the disclosure, a method, a computer-readable medium, and an apparatus are provided for wireless communication at a user equipment (UE). The apparatus receives parameters of a machine learning model from a network node. The apparatus calculates a gradient value relative to a parameter of the parameters of the machine learning model, a sign of the gradient value being one of positive or negative. The apparatus transmits or skips transmission of, in a single RE to the network node, an analog signal based on the sign of the gradient value relative to the parameter of the parameters of the machine learning model, the single RE designated for indicating the sign of the gradient value relative to the parameter of the parameters of the machine learning model.

In an aspect of the disclosure, a method, a computer-readable medium, and an apparatus are provided for wireless communication at a network node. The apparatus outputs for transmission parameters of a machine learning model for a plurality of UEs. The apparatus obtains at least one aggregated analog signal in a pair of REs designated for the plurality of UEs to indicate a gradient value relative to a parameter of the parameters of the machine learning model of the plurality of UEs, the at least one aggregated analog signal obtained in the pair of REs representing a plurality of analog signals accumulatively obtained from the plurality of UEs at the network node, each analog signal of the plurality of analog signals indicating the gradient value relative to the parameter of the parameters of the machine learning model calculated at corresponding UE of the plurality of UEs, the gradient value including a positive gradient value or a negative gradient value. The apparatus updates the parameter of the parameters of the machine learning model based on the at least one aggregated analog signal obtained in the pair of REs.

In an aspect of the disclosure, a method, a computer-readable medium, and an apparatus are provided for wireless communication at a network node. The apparatus outputs for transmission parameters of a machine learning model for a plurality of UEs. The apparatus obtains an aggregated analog signal in a single RE designated for the plurality of UEs to indicate a sign of a gradient value relative to a parameter of the parameters of the machine learning model of the plurality of UEs, the aggregated analog signal obtained in the single RE representing a plurality of analog signals accumulatively obtained from the plurality of UEs at the network node, each analog signal of the plurality of analog signals indicating that the sign of the gradient value relative to the parameter of the parameters of the machine learning model calculated at corresponding UE of the plurality of UEs is one of positive or negative. The apparatus updates the parameter of the parameters of the machine learning model based on the aggregated analog signal obtained in the single RE.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is an example of the AI/ML algorithm of a method of wireless communication.

FIG. 5 is an example of indicating ML parameter of a method of wireless communication.

FIG. 6 is an example of indicating ML parameter of a method of wireless communication.

FIG. 7 is an example of indicating ML parameter of a method of wireless communication.

FIG. 8 is a call-flow diagram of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a diagram illustrating an example of a hardware implementation for an example apparatus and/or network entity.

FIG. 18 is a diagram illustrating an example of a hardware implementation for an example network entity.

FIG. 19 is a diagram illustrating an example of a hardware implementation for an example network entity.

### DETAILED DESCRIPTION

A machine learning model may include tens, hundreds, thousands of parameters or more. In some aspects, multiple UEs may contribute to a federated learning training session. However, the transmission of local gradients to the server may incur a large amount of overhead. In some aspects, over-the-air aggregation may be used to obtain a sum of gradient values from multiple UEs, which may reduce the overhead for the federated learning. Aspects presented herein provide an over-the-air aggregation mechanism that is robust to, e.g., insensitive to, phase uncertainties. The reduced sensitivity to phase uncertainty may allow for a relaxation of phase synchronization between devices, which may reduce complexity for federated learning. Aspects presented herein provide a non-coherent over-the-air aggregation mechanism that allows for gradient reporting in a more effective manner and/or a more efficient manner. In some aspects, the UEs may report a gradient value, e.g., an absolute magnitude of the gradient using a pair of REs. The reporting of the magnitude may allow for the received energy at the network to be proportional to the number of UEs computing a negative or positive value and may provide additional confidence in the gradient sign determined by the network. In some aspects, the UE may use on-off signaling to indicate a positive gradient or a negative gradient using a single RE, which may further reduce the overhead for gradient reporting.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

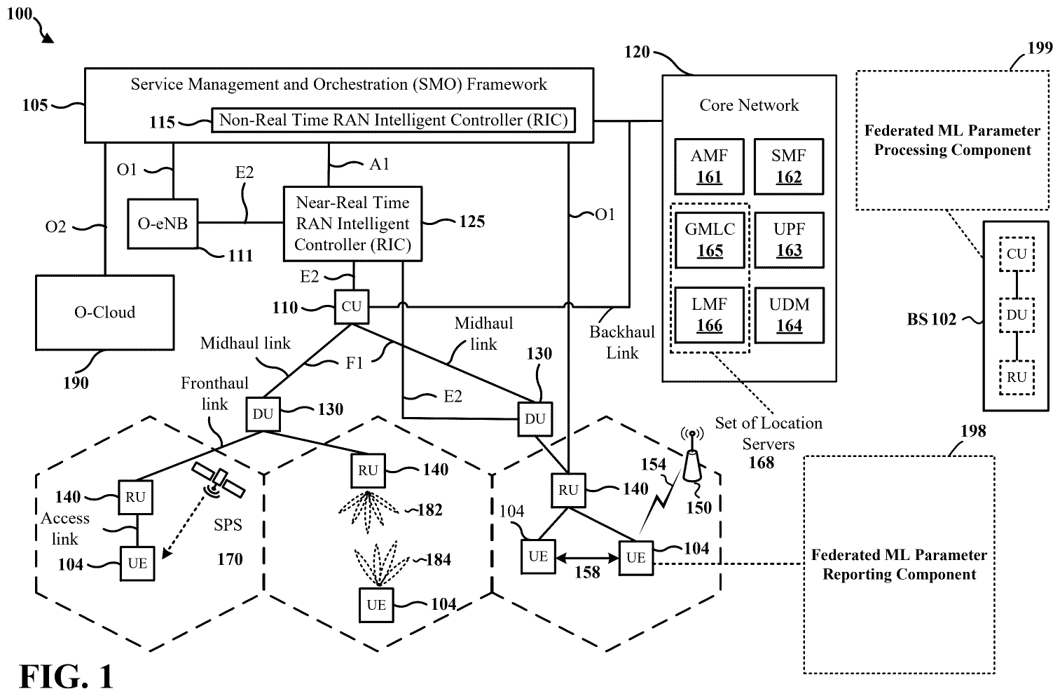

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a federated ML parameter reporting component 198 configured to receive parameters of a machine learning model from a network node; calculate a gradient value relative to a parameter of the parameters of the machine learning model, the gradient value including a positive gradient value or a negative gradient value; and transmit, in one RE of a pair of REs to the network node, an analog signal indicating a magnitude of the gradient value relative to the parameter of the parameters of the machine learning model, the pair of REs designated for indicating the gradient value relative to the parameter of the parameters of the machine learning model. In some aspects, the federated ML parameter reporting component 198 may be configured to receive parameters of a machine learning model from a network node; calculate a gradient value relative to a parameter of the parameters of the machine learning model, the gradient value including a positive gradient value or a negative gradient value; and transmit or skip transmission of, in a single resource element (RE) to the network node, an analog signal based on the gradient value relative to the parameter of the parameters of the machine learning model, the single RE designated for indicating the positive gradient value or the negative gradient value of the gradient value relative to the parameter of the parameters of the machine learning model.

In certain aspects, the base station 102 may include a federated ML parameter processing component 199 configured to output for transmission parameters of a machine learning model for a plurality of UEs; obtain at least one aggregated analog signal in a pair of REs designated for the plurality of UEs to indicate a gradient value relative to a parameter of the parameters of the machine learning model of the plurality of UEs, the at least one aggregated analog signal obtained in the pair of REs representing a plurality of analog signals accumulatively obtained from the plurality of UEs at the network node, each analog signal of the plurality of analog signals indicating the gradient value relative to the parameter of the parameters of the machine learning model calculated at corresponding UE of the plurality of UEs, the gradient value including a positive gradient value or a negative gradient value; and generate an updated parameter information of the parameter of the parameters of the machine learning model based on the at least one aggregated analog signal obtained in the pair of REs. In some aspects, the federated ML parameter processing component 199 may be configured to output for transmission parameters of a machine learning model for a plurality of UEs; obtain an aggregated analog signal in a single RE designated for the plurality of UEs to indicate a gradient value relative to a parameter of the parameters of the machine learning model of the plurality of UEs, the aggregated analog signal obtained in the single RE representing a plurality of analog signals accumulatively obtained from the plurality of UEs at the network node, each analog signal of the plurality of analog signals indicating that gradient value relative to the parameter of the parameters of the machine learning model calculated at corresponding UE of the plurality of UEs being one of a positive gradient value or a negative gradient value; and generate at least one updated parameter information of the parameter of the parameters of the machine learning model based on the aggregated analog signal obtained in the single RE.

Although the following description may be focused on 5G NR, the concepts described herein may be applicable to other similar areas, such as LTE, LTE-A, CDMA, GSM, and other wireless technologies.

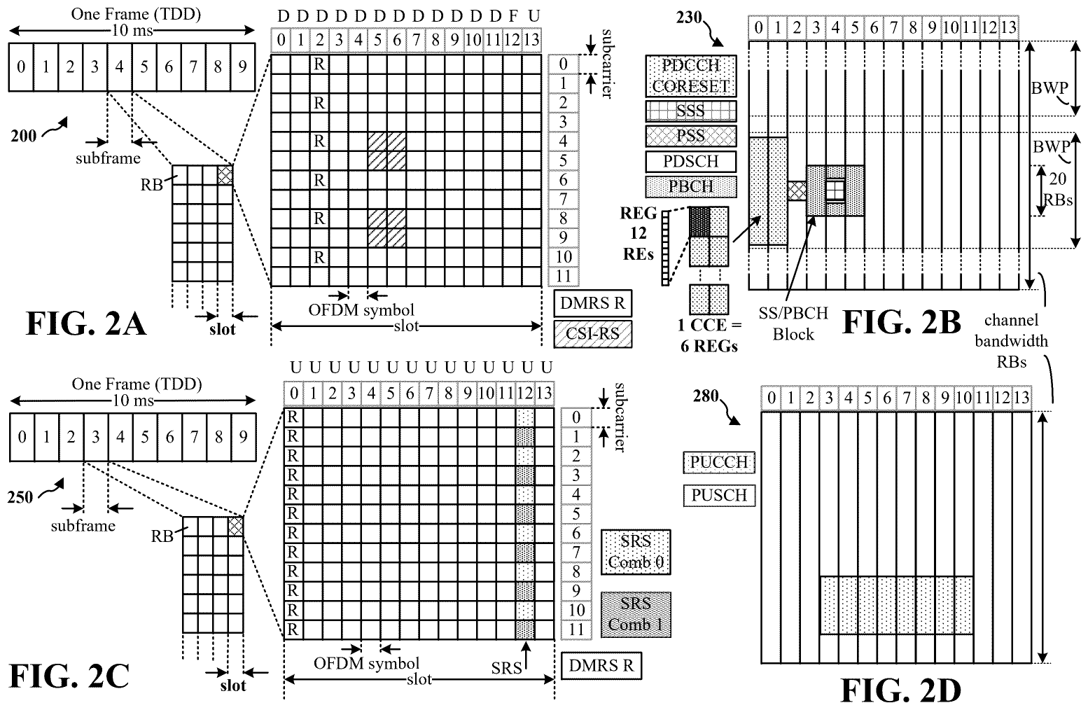

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| | Δf = 2^{μ} · | |
| μ | 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

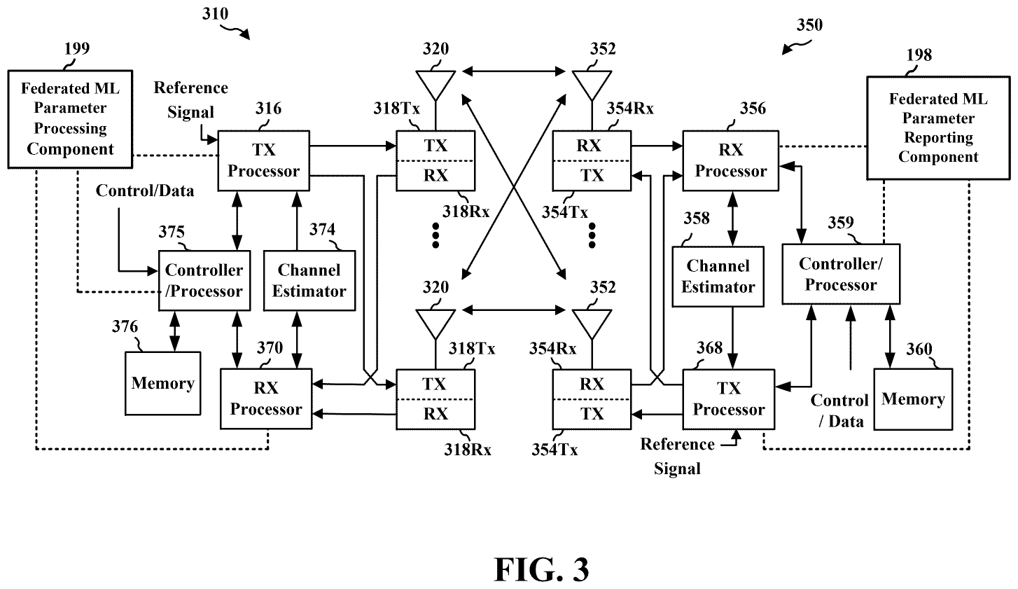

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the federated ML parameter reporting component 198 of FIG. 1. At least one of the TX processor 316, the RX processor 370, and the controller/processor 375 may be configured to perform aspects in connection with the federated ML parameter processing component 199 of FIG. 1.

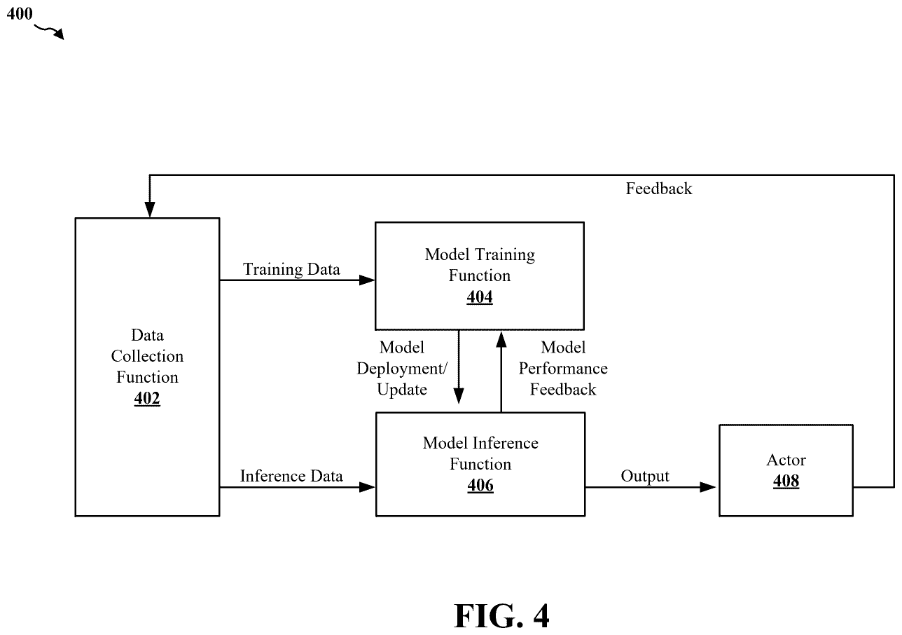

FIG. 4 is an example of the AI/ML algorithm 400 of a method of wireless communication. The AI/ML algorithm 400 may include various functions including a data collection function 402, a model training function 404, a model inference function 406, and an actor 408.

The data collection function 402 may be a function that provides input data to the model training function 404 and the model inference function 406. The data collection function 402 may include any form of data preparation, and it may not be specific to the implementation of the AI/ML algorithm (e.g., data pre-processing and cleaning, formatting, and transformation). The examples of input data may include, but not limited to, measurements from network entities including UEs or network nodes, feedback from the actor 408, output from another AI/ML model. The data collection function 402 may include training data, which refers to the data to be sent as the input for the model training function 404, and inference data, which refers to be sent as the input for the model inference function 406.

The model training function 404 may be a function that performs the ML model training, validation, and testing, which may generate model performance metrics as part of the model testing procedure. The model training function 404 may also be responsible for data preparation (e.g. data pre-processing and cleaning, formatting, and transformation) based on the training data delivered or received from the data collection function 402. The model training function 404 may deploy or update a trained, validated, and tested AI/ML model to the model inference function 406, and receive a model performance feedback from the model inference function 406.

The model inference function 406 may be a function that provides the model inference output (e.g. predictions or decisions). The model inference function 406 may also perform data preparation (e.g. data pre-processing and cleaning, formatting, and transformation) based on the inference data delivered from the data collection function 402. The output of the model inference function 406 may include the inference output of the AI/ML model produced by the model inference function 406. The details of the inference output may be use-case specific.

The model performance feedback may refer to information derived from the model inference function 406 that may be suitable for improvement of the AI/ML model trained in the model training function 404. The feedback from the actor 408 or other network entities (via the data collection function 402) may be implemented for the model inference function 406 to create the model performance feedback.

The actor 408 may be a function that receives the output from the model inference function 406 and triggers or performs corresponding actions. The actor 408 may trigger actions directed to network entities including the other network entities or itself. The actor 408 may also provide a feedback information that the model training function 404 or the model inference function 406 to derive training or inference data or performance feedback. The feedback may be transmitted back to the data collection function 402.

A UE and/or network entity (centralized and/or distributed units) may use machine-learning algorithms, deep-learning algorithms, neural networks, reinforcement learning, regression, boosting, or advanced signal processing methods for aspects of wireless communication, e.g., with a base station, a TRP, another UE, etc.

In some aspects described herein, an encoding device (e.g., a UE) may train one or more neural networks to learn dependence of measured qualities on individual parameters. Among others, examples of machine learning models or neural networks that may be comprised in the UE and/or network entity include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; bayesian networks; genetic algorithms; Deep convolutional networks (DCNs) configured with additional pooling and normalization layers; and Deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivates, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution AxB operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., including any of feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processor for training the machine learning model. An output of one node is connected as the input to another node. Connections between nodes may be referred to as edges, and weights may be applied to the connections/edges to adjust the output from one node that is applied as input to another node. Nodes may apply thresholds in order to determine whether, or when, to provide output to a connected node. The output of each node may be calculated as a non-linear function of a sum of the inputs to the node. The neural network may include any number of nodes and any type of connections between nodes. The neural network may include one or more hidden nodes. Nodes may be aggregated into layers, and different layers of the neural network may perform different kinds of transformations on the input. A signal may travel from input at a first layer through the multiple layers of the neural network to output at a last layer of the neural network and may traverse layers multiple times.

In some aspects, a plurality of UEs may include machine learning models with global parameters, and various implementation may be provided for training global parameters of the machine learning models for the plurality of UEs. In one aspect, the plurality of UEs may transmit the training data to the network node, and the network node may train adjust the global parameter based on the training data received from the plurality of UEs and transmit the updated global parameters to the plurality of UEs. Here, communicating the training data from the plurality of UEs to the network node may cause a heavy traffic.

In another aspect, a federated learning implementation may be provided for training global parameters of the machine learning models for the plurality of UEs. The federated learning may refer to a method of training the global parameters of the machine learning models over the wireless communications where clients (e.g., the UEs) may train the local machine learning models and provide the trained local parameter to a central server (e.g., the network node), and the network node may update the global parameters of machine learning models and distribute the updated global parameters to the clients (e.g., the UEs). The federated learning approach may enable efficient learning by utilizing training data from many diverse clients (e.g., all available UEs) and without exchanging the actual local training data (e.g., communicating model-related information).

An Over the Air (OTA) aggregation scheme may be implemented to reduce the overhead specified for transmitting local model information over wireless resources. That is, based on the OTA aggregation, the data of the local model information from the plurality of UEs may be transmit in an aggregated manner, and the network node may receive the aggregated data to determine the sum of the local model information from the plurality of UEs. The OTA aggregation may generally be associated with tight synchronization, especially in phase, which may be challenging. In another aspect, a non-coherent OTA aggregation scheme may be implemented to reduce the tight phase synchronization specification, and perform the conventional OTA scheme with perfect phase sync with an increase of resource utilization.

The federated learning may provide an effective means to train a global machine learning model in a semi-distributed manner. In the federated learning, a number of UEs (e.g., multiple clients) may employ the same machine learning model structure for a certain task of interest and the number of UEs may locally train their model parameters based on their observations (e.g., the local training data). Periodically, each of the multiple clients may send information about the updated (e.g., locally trained) model parameters to a server (e.g., the network node), and the server may compile the information of the updated model parameters received from all the multiple clients to create a global (e.g., aggregated) model parameter that then may be forwarded to the multiple clients to apply to the local machine learning models.

In one example, a stochastic gradient descend (SGD) model training may be implemented to compile the information of the updated model parameters received from all the multiple clients, and the updated global parameter generated by the server at an iteration i, e.g., at a specific point of time or epoch, may be represented as

$${θ}^{i} = {θ}^{i - 1} - {η}^{i} \frac{1}{{N}_{{UE}_{S}}} {\sum }_{n = 1}^{{N}_{{UE}_{S}}} {g}_{n}^{i} ,$$

where θⁱ may represent a vector of the global model parameter at the iteration i, gₙⁱ may represent the gradient vector values computed by the n^{th} UE at the iteration i, N_{UEs} may represent the number of UEs participating in the i^{th} round (or iteration) and ηⁱ may represent the learning rate.

Here, the above formula may assume that each UE performs the local update using a single training data for the sake of simplicity, but the aspects of the current disclosure are not limited thereto. In general, the local training of the machine learning model may be performed over multiple training data, and the number of the training data may be different among multiple UEs, and a weighted sum of the gradient values may be configured to compute the vector of the global model parameter.

For example, a typical machine learning model may have a large number of machine learning parameters (e.g., 10s or 100s of thousands of parameters). In a wireless communication environment of multiple UEs contributing to the federated learning training session, the multiple UEs may be configured to transmit information about the gradients of the large number of machine learning parameters to the server. The multiple UEs separately transmitting the information about the gradients of the local parameters may cause an increased network overhead.

In one aspect, the SGD model training may be specified to generate the updated global parameter based on a sum of the gradient vector values gₙⁱ for all n, without the knowledge of the individual gradient vector values gₙⁱ for all n. Therefore, the gradient vector values gₙⁱ may be transmitted to the server with the concept of OTA aggregation (a.k.a. OTA computation). Under the OTA aggregation implementation, the server may reserve at least one RE for communicating each machine learning model parameter, and each UE may transmit the gradients of each model parameter over the corresponding at least one RE using an analog pulse-amplitude modulation (PAM) signal (e.g., analog modulation). For example, the PAM signal may be transmitted over the in-phase and quadrature dimension, and each RE may accommodate two model parameters in a case the symbol transmitted over that RE is an analog complex value.

The server may monitor each RE and receive the superposition (e.g., the summation) of the gradient values of the corresponding gradients machine learning parameter from all available (or participating) UEs, which is the information that the server may consider to update the corresponding model parameter based on the SGD model training. Effectively, the OTA aggregation may render the federated learning scalable with respect to the number of UEs participating in the learning, achieving a reduction of the communication overhead by a factor proportional to the number of UEs participating in the federated learning. Considering that the machine learning models include a great number of parameters (e.g., 10s or 100s of thousands of parameters), the reduced communication overhead may be significant.

The wireless communications may be performed in the presence of channel imperfections, such as multipath, frequency and time/clock offsets between the transmission and the reception, etc. In one example, instead of receiving Σₙ₌₁^{N}^{_{UES}} gₙⁱ, the server implemented with the OTA aggregation may observe Σₙ₌₁^{N}^{_{UES}} hₙⁱαₙⁱ\sqrt{pₙⁱ}gₙⁱ, where hₙⁱ may represent a channel imperfections (including the path-loss effects) experienced by the n^{th} UE, which may be in complex-value, pₙⁱ may represent the transmit power of the UE (e.g., when the gradient has a normalized average power), and αₙⁱ may represent a complex rotation that may be applied by the UE to compensate the phase distortions due to channel and timing/frequency offsets. Here, the example provides that the same channel condition is experienced and the same transmit power is used over all REs, but the aspects of the current disclosure are not limited thereto, and different REs may experience different channel condition and the transmit power used by the UE may be different.

To accommodate the OTA aggregation implementation, the channel condition and the UE implementation may be configured to achieve hₙⁱαₙⁱ\sqrt{pₙⁱ}=C, where C may be a constant (e.g., one (1)) for all UEs (e.g., identified by index n). Therefore, the wireless network may be configured with a tight synchronization including a power control to compensate for the path losses, and a phase synchronization to compensate for the phase misalignment due to multipath propagation, carrier frequency offset and timing mismatches between each UE and server.

On top of configuring the wireless network with the tight synchronization for the OTA aggregation round, clock/oscillator drifts between the time of completing the synchronization procedure and performing the time OTA aggregation transmissions may cause a significant uncertainty in the phase synchronization. For example, with the baseband signal transmitted by the UE denoted as s_{BB}(t) (e.g., waveform carrying two gradient values over in-phase and quadrature components) and a timing offset of t₀>0 with respect to the server time reference, the signal observed by the server may result as the following: y(t)=Re{s_{BB}(t−t₀)e^{i2πf}^{_{c}}^{(t-t}^{₀}⁾}≈Re{s_{BB}(t)e^{iϕ}^{₀}e^{i2πf}^{_{c}}^{t}} where the phase rotation ϕ₀=2π_{fc}t₀ may become equal to 2Ti (total phase uncertainty) even with a small time offset, e.g., 0.17 ns for fc=5.9 GHz. According to the current example, a sample-level timing accuracy may be configured to achieve the phase synchronicity, which may be very difficult to achieve and maintain, especially in the OFDM transmission schemes including a cyclic-prefix-level synchronization, which is coarser than the sample-level synchronization. Therefore, the OTA aggregation scheme may be configured to be insensitive or robust to the phase uncertainties. The OTA aggregation scheme insensitive or robust to the phase uncertainties may relax the phase synchronization configurations of OTA and enable providing the federated learning with the OTA aggregation implementation for the wireless communication.

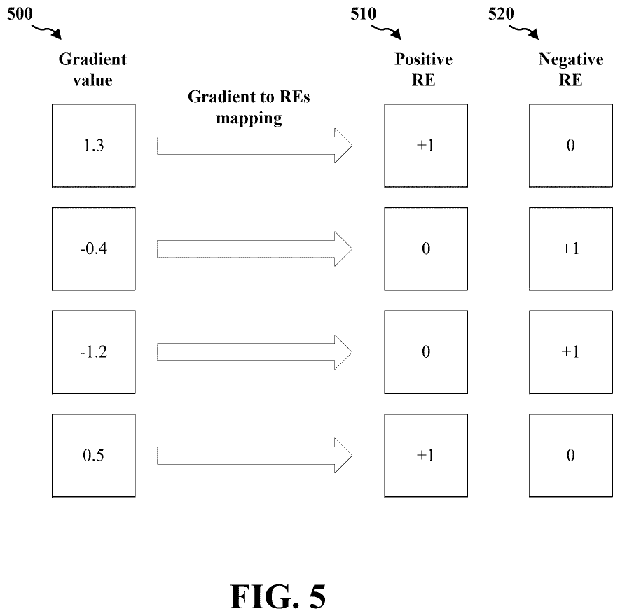

FIG. 5 is a first example of indicating machine learning parameter of a method of wireless communication. The first example of indicating the machine learning parameters may be a non-coherent OTA aggregation including a sign SGD model for the federated training of the machine learning parameters. In the sign SGD model, the UEs, instead of reporting their local gradients, may provide the sign (e.g., + or −) of the local gradients (and not providing the gradient magnitude information) to the server, and the server may perform a majority vote binary decision (e.g., the gradient value transmitted to the server may be set as +1 or −1, depending on whether more UEs reported positive or negative gradient signs, respectively). The aspects of the current disclosure provide that the gradient value may be transmitted as a PAM signal with +1 or −1 value, but the gradient value may be set to have different constant value, e.g., +p or −p, p being the real number. The sign SGD model may be a valid low-complexity or low-overhead implementation of SGD model for machine learning training.

The implementation of the first example of the non-coherent OTA aggregation including the sign SGD model for the federated training of the machine learning parameter may include two REs (e.g., a pair of REs) reserved for each gradient element, compared to assigning one (1) RE per 2 gradients with I/Q signal transmission. Here, the pair of REs may include a first RE of a positive sign RE, and a second RE of a negative sign RE. That is, the server may assign (e.g., through the network node) a pair or REs for a plurality of UEs to transmit the gradient value using analog signals (e.g., PAM signal), the pair of REs including the positive sign RE dedicated for the plurality of UEs to communicate the analog signals corresponding to the positive gradient values, and the negative sign RE dedicated for the plurality of UEs to communicate the analog signals corresponding to the negative gradient values.

For a given gradient value, each UE may transmit a constant value (e.g., +p, p being a real number) over one RE that corresponds to the sign of the gradient value and not transmit any signal over the other RE. For example, for a positive gradient value, a UE may transmit the analog signal that represents +1 value over the positive sign RE of the RE pair, and for a negative gradient value, a UE may transmit the analog signal that represents +1 value over the negative sign RE of the RE pair.

FIG. 5 shows how a UE may map four (4) locally-computed gradient values 500 to transmission values over corresponding sign REs 510 and 520. The server may assign (e.g., through the network node) a pair or REs 510 and 520 for the UE, and the pair of REs 510 and 520 may include a positive sign RE 510 and a negative sign RE 520. For example, for the positive gradient values, e.g., 1.3 or 0.5, the UE may transmit the analog signal representing a value of +1 in the positive sign RE 510, and for the negative gradient values, e.g., −0.4 or −1.2, the UE may transmit the analog signal representing a value of +1 in the negative sign RE 520.

Assuming ideal transmission power control, a first aggregated analog signal received at the server in the positive sign RE may be represented as

$${y}_{+} = {\sum }_{{n}_{+} = 1}^{{N}_{+}} \vert {g}_{{n}_{+}} \vert {e}^{i {ϕ}_{{n}_{+}}} ,$$

where N₊ may represent the number of UEs with the positive gradient values, |gₙ₊| may represent the magnitude of the positive-computed gradient value, and ϕₙ_{₊} may represent the arbitrary phase experienced by the UE with index n due to time-phase-frequency errors, and a second aggregated analog signal received at the server in the negative sign RE may be represented as

$${y}_{-} = {\sum }_{{n}_{-} = 1}^{{N}_{-}} \vert {g}_{{n}_{-}} \vert {e}^{i {ϕ}_{{n}_{-}}} ,$$

where N₋ may represent the number of UEs with the negative gradient values, |gₙ₋| may represent the magnitude of the positive-computed gradient value, and ϕₙ₋ may represent the arbitrary phase experienced by the UE with index n₋ due to time-phase-frequency errors.

The server may determine an aggregated gradient value based on the first aggregated analog signal received in the positive sign RE and the second aggregated analog signal received in the negative sign RE. In one aspect, the server may compare a first magnitude of the first aggregated analog signal received in the positive sign RE and a second magnitude of the second aggregated analog signal received in the negative sign RE. The server may compare the |y₊|² and the |y₋|², and determine the aggregated gradient value based on the comparison of the |y₊|² and the |y₋|². In one example, the server may declare that the aggregated gradient value is +1 based on determining that the first magnitude of the first aggregated analog signal is greater than the second magnitude of the second aggregated analog signal (e.g., |y₊|²>|y₋|²). In another example, the server may declare that the aggregated gradient value is −1 based on determining that the first magnitude of the first aggregated analog signal is smaller than or equal to the second magnitude of the second aggregated analog signal (e.g., |y₊|²≤|y₋|²). The server may update the parameter based on the aggregated gradient value, and broadcast (or transmit) the updated parameter to the plurality of UEs.

According to the first example of non-coherent OTA aggregation as illustrated in FIG. 5, the server may train the global parameter with a relaxed phase synchronization. The aggregated gradient value calculated based on the first example of the non-coherent OTA aggregation may be relevant even under a total phase uncertainty (e.g., the phase being randomly distributed between 0 and 2π with a sufficiently large number of clients/UEs). The non-coherent OTA aggregation scheme may also relax the specification with respect to the power control and does not consider the number of UEs participating in each round. Under the first example of the non-coherent OTA aggregation, the plurality of UEs may transmit a unit-magnitude signal over the corresponding sign RE instead of transmitting the actual gradient value, and therefore, some information may be lost in each training round, which may cause a slower convergence.

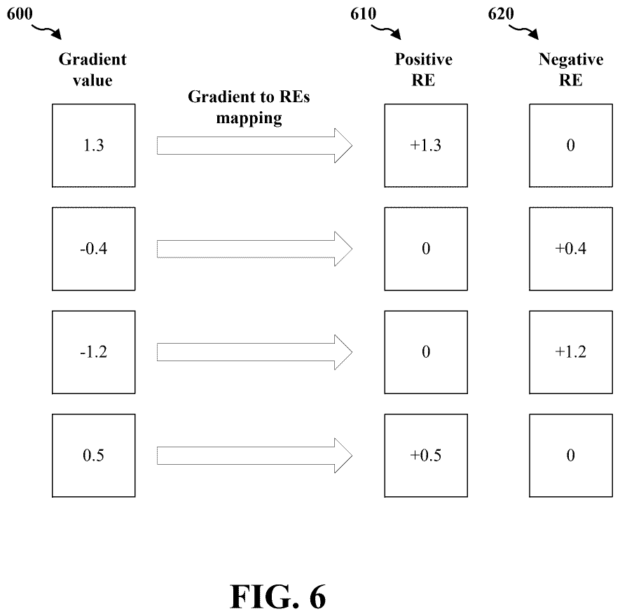

FIG. 6 is a second example of indicating machine learning parameter of a method of wireless communication. The second example of indicating the machine learning parameters may be a non-coherent OTA aggregation including a modified sign SGD model for the federated training of the machine learning parameter. The second example of the non-coherent OTA aggregation including the modified sign SGD model for the federated training of the machine learning parameter may follow substantially the same scheme as the first example of the non-coherent OTA aggregation, with the exception that, instead of sending a PAM signal representing a constant value (e.g., +1), the UE may transmit the absolute magnitude of the gradient value over the corresponding sign RE (e.g., the positive sign RE or the negative sign RE).

The implementation of the second example of the non-coherent OTA aggregation may include two REs (e.g., a pair of REs) reserved for each gradient element. Here, the pair of REs may include a first RE of a positive sign RE, and a second RE of a negative sign RE. That is, the server may assign (e.g., through the network node) a pair or REs for a plurality of UEs to transmit the gradient value using analog signals (e.g., PAM signal), the pair of REs including the positive sign RE dedicated for the plurality of UEs to communicate the analog signals corresponding to the positive gradient values, and the negative sign RE dedicated for the plurality of UEs to communicate the analog signals corresponding to the negative gradient values.

For a given gradient value, each UE may transmit the value corresponding to the absolute magnitude of the gradient over one RE that corresponds to the sign of the gradient value and not transmit any signal over the other RE. For example, for a positive gradient value, a UE may transmit the analog signal that represents the absolute magnitude of the gradient value over the positive sign RE of the RE pair, and for a negative gradient value, a UE may transmit the analog signal that represents the absolute magnitude of the gradient value over the negative sign RE of the RE pair.

FIG. 6 shows how a UE may map four (4) locally-computed gradient values 600 to transmission values over corresponding sign REs 610 and 620. The server may assign (e.g., through the network node) a pair or REs 610 and 620 for the UE, and the pair of REs 610 and 620 may include a positive sign RE 610 and a negative sign RE 620. For example, a UE may observe a positive value of +1.3 or +0.5 for a given gradient, and the UE may transmit the value of +1.3 or +0.5 over the corresponding positive sign RE 610. A UE may observe the value of −0.4 or −1.2 for a given gradient, and the UE may transmit the value of +0.4 or +1.2 over the corresponding negative sign RE 620.

Assuming ideal transmission power control, a first aggregated analog signal received at the server in the positive sign RE may be represented as

$${y}_{+} = {\sum }_{{n}_{+} = 1}^{{N}_{+}} \vert {g}_{{n}_{+}} \vert {e}^{i {ϕ}_{{n}_{+}}} ,$$

where N₊ may represent the number of UEs with the positive gradient value, |gₙ₊| may represent the magnitude of the positive-computed gradient value, and ϕₙ₊ may represent the arbitrary phase experienced by the UE with index n₊ due to time-phase-frequency errors, and a second aggregated analog signal received at the server in the negative sign RE may be represented as

$${y}_{-} = {\sum }_{{n}_{-} = 1}^{{N}_{-}} \vert {g}_{{n}_{-}} \vert {e}^{i {ϕ}_{{n}_{-}}} ,$$

where N₋ may represent the number of UEs with the negative gradient value, |g₋| may represent the magnitude of the positive-computed gradient value, and ϕₙ₋ may represent the arbitrary phase experienced by the UE with index n₋ due to time-phase-frequency errors.

The server may determine an aggregated gradient value based on the first aggregated analog signal received in the positive sign RE and the second aggregated analog signal received in the negative sign RE. In one aspect, the server may compare a first magnitude of the first aggregated analog signal received in the positive sign RE and a second magnitude of the second aggregated analog signal received in the negative sign RE. The server may compare the |y₊|² and the |y₋|², and determine the aggregated gradient value based on the comparison of the |y₊|² and the |y₋|². In one example, the server may declare that the aggregated gradient value is +1 based on determining that the first magnitude of the first aggregated analog signal is greater than the second magnitude of the second aggregated analog signal (e.g., |y₊|²>|y₋|²). In another example, the server may declare that the aggregated gradient value is −1 based on determining that the first magnitude of the first aggregated analog signal is smaller than or equal to the second magnitude of the second aggregated analog signal (e.g., |y₊|²≤|y₋|²). The server may update the parameter based on the aggregated gradient value, and broadcast (or transmit) the updated parameter to the plurality of UEs.

According to the second example of non-coherent OTA aggregation as illustrated in FIG. 6, the server may train the global parameter with a relaxed phase synchronization. Furthermore, the energy of the aggregated analog signal received in the pair of REs (e.g., positive and negative) may be proportional to the number of UEs computing positive or negative gradient while adding a confidence indication of the gradient sign. In one example, a first UE observing a positive gradient value of +1.4 may be more confident than a second UE observing a positive gradient value of +0.1. The first UE transmitting the analog signal corresponding to the gradient value of +1.4 may have a greater effect on the aggregated gradient value than the second UE transmitting the analog signal corresponding to the gradient value of +0.1. In another example, a half of the plurality of UEs may compute a gradient value +1.6 and a half of the UEs may compute a gradient value −0.001. Based on the first example of non-coherent OTA aggregation as illustrated in FIG. 5, the first aggregated analog signal received in the positive sign RE and the second aggregated analog signal received in the negative sign RE may have the same energy (on average) and the server may have an equal probability to decide that the aggregated gradient value is either +1 or −1, even though +1 would be a more reasonable outcome. Based on the second example of non-coherent OTA aggregation as illustrated in FIG. 6, the first aggregated analog signal received in the positive sign RE may have a larger energy (on average), and therefore, the server may decide that the aggregated gradient value is +1.

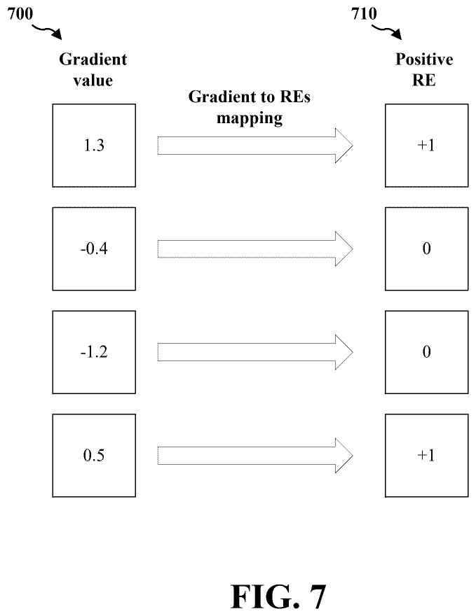

FIG. 7 is a third example of indicating machine learning parameter of a method of wireless communication. The third example of indicating the machine learning parameters may be a non-coherent OTA aggregation including a modified sign SGD model for the federated training of the machine learning parameter including a modified sign SGD model. The implementation of the third example of the non-coherent OTA aggregation including the modified sign SGD model for the federated training of the machine learning parameter may include UEs performing an on-off transmission per gradient value. The first example of the non-coherent OTA aggregation as illustrated in FIG. 5 may be a binary frequency shift keying (FSK) transmission per gradient from the UE's perspective, which provides transmitting the binary data over the frequency (e.g., the RE) corresponding to the symbol sign. The third example of the non-coherent OTA aggregation as illustrated in FIG. 7 may be the on-off binary signaling per gradient.

The third example of the non-coherent OTA aggregation may follow substantially the same scheme as the first example of the non-coherent OTA aggregation, with the exception that each gradient is associated with a single positive sign RE (e.g., no negative sign RE configured). The UE may observe a positive gradient value, and the UE may transmit an analog signal representing a constant value (e.g., the value of +1) over the positive sign RE, and the UE may observe a negative gradient value, and the UE may defer from transmitting a signal for that particular gradient value (e.g., the value of 0).

FIG. 7 shows how a UE may map four (4) locally-computed gradient values 700 to transmission values over the positive sign RE 710. The server may assign (e.g., through the network node) the positive sign RE 710. For example, for the positive gradient values, e.g., 1.3 or 0.5, the UE may transmit the analog signal representing a value of +1 in the positive sign RE 710 to indicate that the corresponding gradient value has a positive sign, and for the negative gradient values, e.g., −0.4 or −1.2, the UE may defer transmitting the analog signal in the positive sign RE 710 to indicate that the corresponding gradient value has a negative sign.

Assuming ideal transmission power control, a first aggregated analog signal received at the server in the positive sign RE may be represented as

$${y}_{+} = {\sum }_{{n}_{+} = 1}^{{N}_{+}} \vert {g}_{{n}_{+}} \vert {e}^{i {ϕ}_{{n}_{+}}} ,$$

where N₊ may represent the number of UEs with the positive gradient value, |gₙ₊| may represent the magnitude of the positive-computed gradient value, and ϕₙ₊ may represent the arbitrary phase experienced by the UE with index n due to time-phase-frequency errors.

The server may determine an aggregated gradient value based on the first aggregated analog signal received in the positive sign RE and a threshold value. In one aspect, the server may compare a first magnitude of the first aggregated analog signal received in the positive sign RE with a threshold value. The server may compare the |y₊|² and the threshold value, and determine the aggregated gradient value based on the comparison of the |y₊|² and the threshold value. In one example, the server may declare that the aggregated gradient value is +1 based on determining that the first magnitude of the first aggregated analog signal is greater than the threshold value (e.g., |y₊|²>threshold value). In another example, the server may declare that the aggregated gradient value is −1 based on determining that the first magnitude of the first aggregated analog signal is smaller than or equal to the second magnitude of the second aggregated analog signal (e.g., |y₊|²; threshold value). The threshold value may be determined or configured by the server. The server may update the parameter based on the aggregated gradient value, and broadcast (or transmit) the updated parameter to the plurality of UEs.

According to the third example of non-coherent OTA aggregation as illustrated in FIG. 7, the server may train the global parameter with a relaxed phase synchronization. Compared to the first example of non-coherent OTA aggregation as illustrated in FIG. 5, the third example of non-coherent OTA aggregation may configure a single RE per gradient instead of two (2), which is the half the resources configured for the first example of non-coherent OTA aggregation.

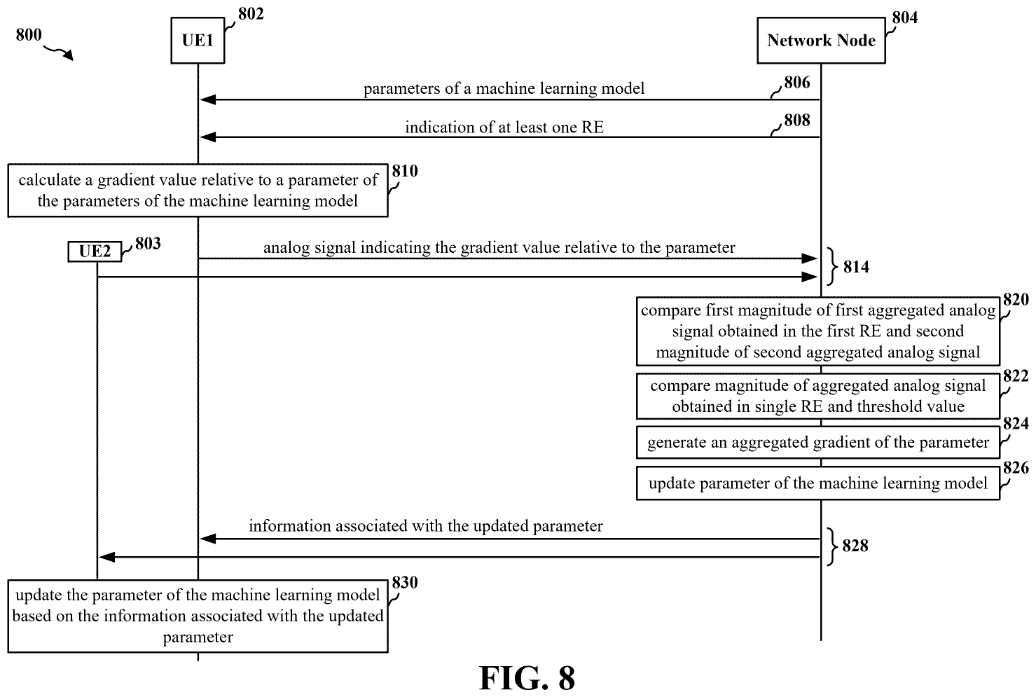

FIG. 8 is a call-flow diagram 800 of a method of wireless communication. The call-flow diagram 800 may include a first UE 802, a second UE 803, and a network node 804 of a non-coherent OTA aggregation for federated training of the machine learning parameter including a modified sign SGD model. The network node 804 may configure at least one RE for a plurality of UEs including the first UE 802, the at least one RE being designated for transmitting a plurality of analog signals to indicate gradient value relative to a parameter to the network node 804. The network node 804 may obtain at least one aggregated analog signal representing the plurality of analog signals, generate an aggregated gradient of the parameter based on the at least one aggregated analog signal, and update the parameter based on the aggregated gradient. The network node 804 may transmit information associated with the updated parameter of the machine learning model to the plurality of UEs including the first UE 802 and the second UE 803. The plurality of UEs including the first UE 802, the second UE 803, and the network node 804 may update the parameter of the machine learning model based on the updated parameter information.

At 806, the network node 804 may transmit parameters of a machine learning model for the plurality of UEs including the first UE 802 and the second UE 803. The first UE 802 may receive parameters of a machine learning model from the network node 804. Here, the parameters of the machine learning model may be a global parameter of the machine learning model, which may be shared by the plurality of UEs including the first UE 802 and the second UE 803.

At 808, the network node 804 may transmit an indication of at least one RE to the plurality of UEs including the first UE 802 and the second UE 803 to configure the first UE 802 and the second UE 803 to indicate the gradient value relative to the parameter of the parameters of the machine learning model. The first UE 802 may receive an indication of at least one RE from the network node 804, the at least one RE is configured for the plurality of UEs including the first UE 802 and the second UE 803 to indicate the gradient value relative to the parameter of the parameters of the machine learning model.

In the first aspect, the indication may configure a pair of REs for the plurality of UEs including the first UE 802 and the second UE 803. The pair of REs designated for indicating the parameters of the machine learning model may include a first RE designated for indicating the positive gradient value, and a second RE designated for indicating the negative gradient value.

In the second aspect, the indication may configure a single RE for the plurality of UEs including the first UE 802 and the second UE 803. Here, the single RE may be designated for indicating the positive gradient value or the negative gradient value of the gradient value relative to the parameter of the parameters of the machine learning model.

At 810, the first UE 802 may calculate a gradient value relative to a parameter of the parameters of the machine learning model. Here, the gradient value may include a positive gradient value or a negative gradient value. The first UE 802 and the second UE 803 may separately perform the training of the parameter of the parameters received at 806, and calculate the gradient value of the parameter based on the training of the parameter. The first UE 802 and the second UE 803 may use different training data set, so the first UE 802 and the second UE 803 may calculate different gradient values based on the training of the parameter.

At 814, the first UE 802 may transmit, in at least one RE to the network node 804, an analog signal indicating the gradient value relative to the parameter of the parameters of the machine learning model. The analog signal is transmitted in the at least one RE configured based on the indication of the at least on RE received from the network node 804 at 808.

In the first aspect, the first UE 802 may transmit, in one RE of a pair of REs to the network node 804, an analog signal indicating a magnitude of the gradient value relative to the parameter of the parameters of the machine learning model. The pair of REs may be designated for indicating the gradient value relative to the parameter of the parameters of the machine learning model as configured by the indication received from the network node 804 at 808. The pair of REs designated for indicating the parameters of the machine learning model may include a first RE designated for indicating the positive gradient value, and a second RE designated for indicating the negative gradient value. The first UE 802 may transmit the analog signal is transmitted in the first RE or the second RE based on the gradient value. For example, the first UE 802 may observe a positive value of +1.3 or +0.5 as the given gradient of the parameter, and the first UE 802 may transmit the analog signal representing the value of +1.3 or +0.5 over the first RE. The first UE 802 may observe a negative value of −0.4 or −1.2 as the given gradient of the parameter, and the first UE 802 may transmit analog signal representing the value of +0.4 or +1.2 over the second RE.

In the second aspect, the first UE 802 may transmit or skip transmission of, in a single RE to the network node 804, an analog signal based on a sign of the gradient value relative to the parameter of the parameters of the machine learning model. The single RE may be designated for indicating the sign of the gradient value relative to the parameter of the parameters of the machine learning model as configured by the indication received from the network node 804 at 808. Here, a presence of the analog signal in the single RE may indicate that the sign of the gradient value is positive, and an absence of the analog signal in the RE may indicate that the sign of the gradient value is negative. For example, for the positive gradient values, e.g., 1.3 or 0.5, the first UE 802 may transmit the analog signal representing a value of +1 in the positive sign RE to indicate that the sign of the gradient value is positive, and for the negative gradient values, e.g., −0.4 or −1.2, the UE may defer transmitting the analog signal in the positive sign RE to indicate that the sign of the gradient value is negative.

The network node 804 may obtain an aggregated analog signal in the at least one RE designated for the plurality of UEs to indicate a gradient value relative to the parameter of the machine learning model of the plurality of UEs. The aggregated analog signal obtained may represent a plurality of analog signals accumulatively obtained from the plurality of UEs at the network node 804. Here, each analog signal of the plurality of analog signals may indicate the gradient value relative to the parameter of the parameters of the machine learning model calculated at corresponding UE of the plurality of UEs.

In the first aspect, the network node 804 may obtain at least one aggregated analog signal in a pair of REs designated for the plurality of UEs to indicate a gradient value relative to a parameter of the parameters of the machine learning model of the plurality of UEs. The at least one aggregated analog signal obtained in the pair of REs may represent a plurality of analog signals accumulatively obtained from the plurality of UEs at the network node 804, each analog signal of the plurality of analog signals indicating the gradient value relative to the parameter of the parameters of the machine learning model calculated at corresponding UE of the plurality of UEs. The gradient value may include a positive gradient value or a negative gradient value. The at least one aggregated analog signal may include a first aggregated analog signal and a second aggregated analog signal, and the pair of REs designated for indicating the parameter of the parameters of the machine learning model may include a first RE and a second RE. The first aggregated analog signal obtained in the first RE may represent a first set of analog signals accumulatively obtained at the network node 804, each analog signal of the first set of analog signals indicating the positive gradient value, and the second aggregated analog signal obtained in the second RE may represent a second set of analog signals accumulatively obtained at the network node 804, each analog signal of the second set of analog signals indicating the negative gradient value. For example, the first aggregated analog signal obtained in the first RE may be represented as

$${y}_{+} = {\sum }_{{n}_{+} = 1}^{{N}_{+}} \vert {g}_{{n}_{+}} \vert {e}^{i {ϕ}_{{n}_{+}}} ,$$

where N₊ may represent the number of UEs with the positive gradient values, |gₙ₊| may represent the magnitude of the positive-computed gradient value, and ϕₙ₊ may represent the arbitrary phase experienced by the UE with index n due to time-phase-frequency errors, and the second aggregated analog signal obtained in the second RE may be represented as

$${y}_{-} = {\sum }_{{n}_{-} = 1}^{{N}_{-}} \vert {g}_{{n}_{-}} \vert {e}^{i {ϕ}_{{n}_{-}}} ,$$

N₋ may represent the number of UEs with the negative gradient values, |g₋| may represent the magnitude of the positive-computed gradient value, and ϕₙ₋ may represent the arbitrary phase experienced by the UE with index n₋ due to time-phase-frequency errors.

In the second aspect, the network node 804 may obtain an aggregated analog signal in a single RE designated for the plurality of UEs to indicate a sign of a gradient value relative to a parameter of the parameters of the machine learning model of the plurality of UEs, the aggregated analog signal obtained in the single RE representing a plurality of analog signals accumulatively obtained from the plurality of UEs at the network node 804. Each analog signal of the plurality of analog signals may indicate that the sign of the gradient value relative to the parameter of the parameters of the machine learning model calculated at corresponding UE of the plurality of UEs is one of positive or negative. Here, at least one aggregated analog signal is obtained in the single RE based on the indication of the single RE. For example, the aggregated analog signal obtained in the single RE may be represented as

$${y}_{+} = {\sum }_{{n}_{+} = 1}^{{N}_{+}} \vert {g}_{{n}_{+}} \vert {e}^{i {ϕ}_{{n}_{+}}} ,$$

where N₊ may represent the number of UEs with the positive gradient value, |gₙ₊| may represent the magnitude of the positive-computed gradient value, and ϕₙ₊ may represent the arbitrary phase experienced by the UE with index n due to time-phase-frequency errors.

At 820, the network node 804 may compare a first magnitude of the first aggregated analog signal obtained in the first RE and a second magnitude of the second aggregated analog signal obtained in the second RE. That is, the network node 804 may compare the |y₊|² and the |y₋|², and determine the aggregated gradient value based on the comparison of the |y₊|² and the |y₋|².

At 822, the network node 804 may compare a magnitude of the aggregated analog signal obtained in the single RE and a threshold value. That is, the network node 804 may compare the |y₊|² and the threshold value, and determine the aggregated gradient value based on the comparison of the |y₊|² and the threshold value. Here, the threshold value may be determined or configured by the network node 804.

At 824, the network node 804 may generate an aggregated gradient of the parameter of the parameters of the machine learning model based on the aggregated analog signal obtained from the plurality of UEs. Particularly the aggregated gradient of the parameter of the machine learning may be generated based on a comparison at 820 or 822.

In the first aspect, in connection with 820, the network node 804 may generate an aggregated gradient of the parameter of the parameters of the machine learning model based on the at least one aggregated analog signal obtained in the pair of REs. The aggregated gradient of the parameter of the parameters of the machine learning model may be generated based on the comparison of the first magnitude and the second magnitude at 820. The aggregated gradient may have a value of +p based on the first magnitude being greater than the second magnitude and the aggregated gradient has a value of −p based on the first magnitude being smaller than or equal to the second magnitude, where the p being a real number. In one example, the network node 804 may declare that the aggregated gradient value is +1 based on determining that |y₊|²>|y₋|². In another example, the server may declare that the aggregated gradient value is −1 based on determining that |y₊|²≤|y₋|².

In the second aspect, in connection with 822, the network node 804 may generate an aggregated gradient of the parameter of the parameters of the machine learning model based on the aggregated analog signal obtained in the single RE. The aggregated gradient of the parameter of the parameters of the machine learning model may be generated based on a comparison of the magnitude of the aggregated analog signal and the threshold value determined at 822. aggregated gradient The aggregated gradient may be generated to have a value of +p based on the magnitude being greater than the threshold value, and the aggregated gradient may be generated to have a value of −p based on the magnitude being smaller than or equal to the threshold value, where p is a real number. For example, p may be +1. In one example, the network node 804 may declare that the aggregated gradient value is +1 based on determining that the |y₊|²>threshold value. In another example, the network node 804 may declare that the aggregated gradient value is −1 based on determining that |y₊|² threshold value. Here, the threshold value may be determined or configured by the network node 804.

At 826, the network node 804 may update the parameter of the machine learning model based on the aggregated gradient generated at 824. The network node 804 may use the aggregated gradient value generated at 824 to update the parameter of the machine learning model.

At 828, the network node 804 may transmit information associated with the updated parameter of the parameters of the machine learning model to the plurality of UEs including the first UE 802 and the second UE 803, the information associated with the updated parameter based at least in part on the aggregated analog signal received at the network node 804. The first UE 802 may receive information associated with the updated parameter of the parameters of the machine learning model from the network node 804, the information associated with the updated parameter based at least in part on the analog signal transmitted to the network node 804. The updated parameter information may include the updated parameter at 826.

At 830, the first UE 802 may update the parameter of the machine learning model based on the information associated with the updated parameter received from the network node 804 at 828. The information associated with the update parameter may include the updated parameter (e.g., the updated global parameter) for the plurality of UEs including the first UE 802, and the first UE 802 may replace the original parameter with the updated parameter from the information associated with the update parameter received from the network node 804.

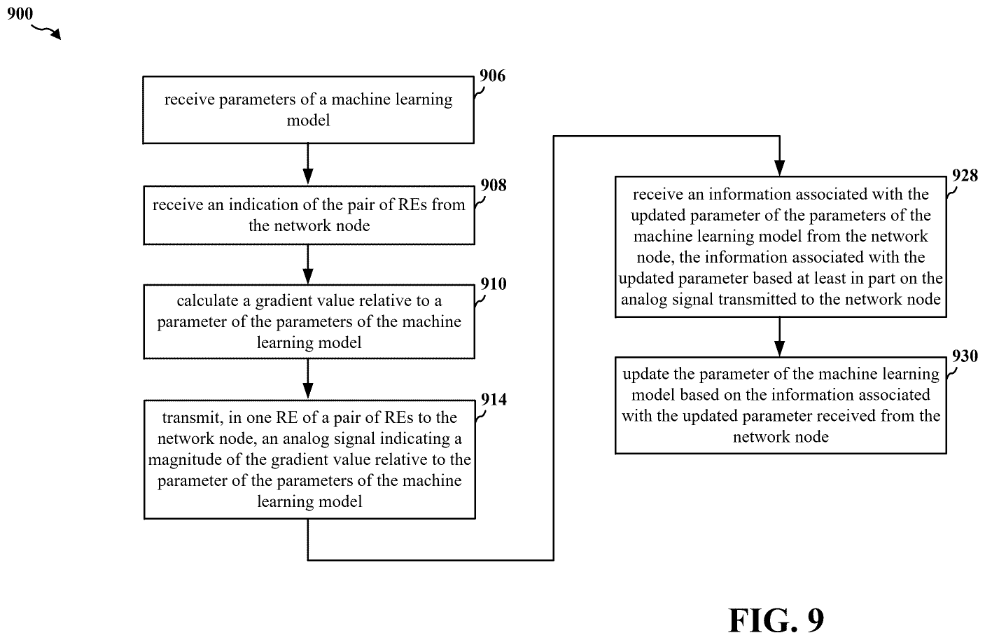

FIG. 9 is a flowchart 900 of a method of wireless communication. The method may be performed by a UE (e.g., the UE 104; the apparatus 1704). The UE may be configured with a pair of REs designated for the UE to transmit an analog signal in one RE of the pair of REs to indicate gradient value relative to a parameter to a network node. The UE may transmit the analog signal representing the gradient value of the parameter in one RE of the pair of REs, receive information associated with an updated parameter information from the network node, and update the parameter of the machine learning model based on the updated parameter information received from the network node.

At 906, the UE may receive parameters of a machine learning model from the network node. Here, the parameters of the machine learning model may be a global parameter of the machine learning model, which may be shared by the plurality of UEs including the UE. For example, at 806, the first UE 802 may receive parameters of a machine learning model from the network node 804. Furthermore, 906 may be performed by a federated ML parameter reporting component 198.

At 908, the UE may receive an indication of a pair of REs from the network node 804, the pair of REs being configured for the plurality of UEs including the UE to indicate the gradient value relative to the parameter of the parameters of the machine learning model. The indication may configure a pair of REs for the plurality of UEs including the UE. The pair of REs designated for indicating the parameters of the machine learning model may include a first RE designated for indicating the positive gradient value, and a second RE designated for indicating the negative gradient value. For example, at 808, the first UE 802 may receive an indication of a pair of REs from the network node 804. Furthermore, 908 may be performed by the federated ML parameter reporting component 198.

At 910, the UE may calculate a gradient value relative to a parameter of the parameters of the machine learning model. Here, the gradient value may include a positive gradient value or a negative gradient value. The UE may perform the training of the parameter of the parameters received at 906 separately from other UEs, and calculate the gradient value of the parameter based on the training of the parameter using a training data set. For example, at 810, the first UE 802 may calculate a gradient value relative to a parameter of the parameters of the machine learning model. Furthermore, 910 may be performed by the federated ML parameter reporting component 198.

At 914, the UE may transmit, in one RE of a pair of REs to the network node, an analog signal indicating a magnitude of the gradient value relative to the parameter of the parameters of the machine learning model. The pair of REs may be designated for indicating the gradient value relative to the parameter of the parameters of the machine learning model as configured by the indication received from the network node at 908. The pair of REs designated for indicating the parameters of the machine learning model may include a first RE designated for indicating the positive gradient value, and a second RE designated for indicating the negative gradient value. The UE may transmit the analog signal is transmitted in the first RE or the second RE based on the gradient value. For example, the UE may observe a positive value of +1.3 or +0.5 as the given gradient of the parameter, and the UE may transmit the analog signal representing the value of +1.3 or +0.5 over the first RE. The UE may observe a negative value of −0.4 or −1.2 as the given gradient of the parameter, and the UE may transmit analog signal representing the value of +0.4 or +1.2 over the second RE. For example, at 814, the first UE 802 may transmit, in one RE of a pair of REs to the network node 804, an analog signal indicating a magnitude of the gradient value relative to the parameter of the parameters of the machine learning model. Furthermore, 914 may be performed by the federated ML parameter reporting component 198.

At 928, the UE may receive information associated with the updated parameter of the parameters of the machine learning model from the network node, the information associated with the updated parameter based at least in part on the analog signal transmitted to the network node. The updated parameter information may indicate an updated value of the parameter or a gradient value of the parameter. For example, at 826, the first UE 802 may receive information associated with the updated parameter of the parameters of the machine learning model from the network node 804, the information associated with the updated parameter based at least in part on the analog signal transmitted to the network node 804. Furthermore, 926 may be performed by the federated ML parameter reporting component 198.

At 930, the UE may update the parameter of the machine learning model based on the information associated with the updated parameter received from the network node at 928. The information associated with the update parameter information may indicate the updated parameter (e.g., the updated global parameter) for the plurality of UEs including the UE, and the UE may replace the original parameter with the updated parameter from the information associated with the update parameter received from the network node. For example, at 830, the first UE 802 may update the parameter of the machine learning model based on the information associated with the updated parameter received from the network node 804. Furthermore, 928 may be performed by the federated ML parameter reporting component 198.

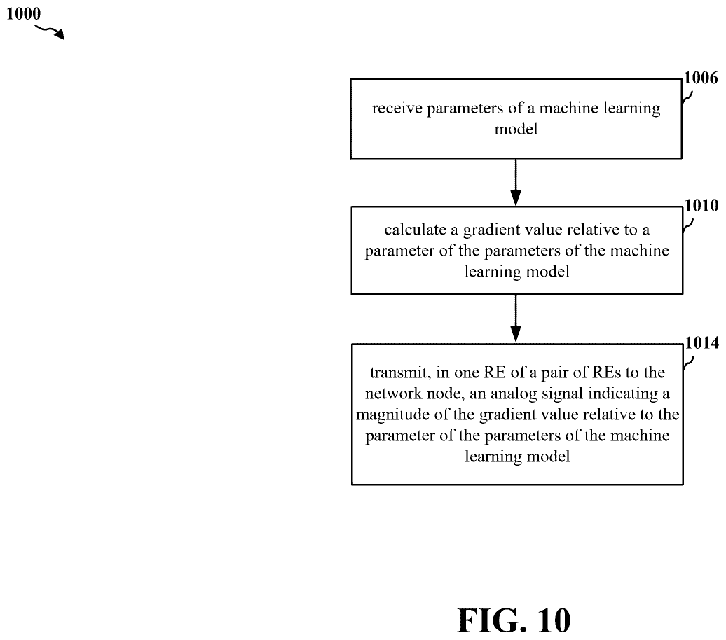

FIG. 10 is a flowchart 1000 of a method of wireless communication. The method may be performed by a UE (e.g., the UE 104; the apparatus 1704). The UE may be configured with a pair of REs designated for the UE to transmit an analog signal in one RE of the pair of REs to indicate gradient value relative to a parameter to a network node. The UE may transmit the analog signal representing the gradient value of the parameter in one RE of the pair of REs, receive information associated with an updated parameter information from the network node, and update the parameter of the machine learning model based on the updated parameter information received from the network node.

At 1006, the UE may receive parameters of a machine learning model from the network node. Here, the parameters of the machine learning model may be a global parameter of the machine learning model, which may be shared by the plurality of UEs including the UE. For example, at 806, the first UE 802 may receive parameters of a machine learning model from the network node 804. Furthermore, 1006 may be performed by a federated ML parameter reporting component 198.

At 1010, the UE may calculate a gradient value relative to a parameter of the parameters of the machine learning model. Here, the gradient value may include a positive gradient value or a negative gradient value. The UE may perform the training of the parameter of the parameters received at 1006 separately from other UEs, and calculate the gradient value of the parameter based on the training of the parameter using a training data set. For example, at 810, the first UE 802 may calculate a gradient value relative to a parameter of the parameters of the machine learning model. Furthermore, 1010 may be performed by the federated ML parameter reporting component 198.

At 1014, the UE may transmit, in one RE of a pair of REs to the network node, an analog signal indicating a magnitude of the gradient value relative to the parameter of the parameters of the machine learning model. The pair of REs may be designated for indicating the gradient value relative to the parameter of the parameters of the machine learning model as configured by the indication received from the network node at 1008. The pair of REs designated for indicating the parameters of the machine learning model may include a first RE designated for indicating the positive gradient value, and a second RE designated for indicating the negative gradient value. The UE may transmit the analog signal is transmitted in the first RE or the second RE based on the gradient value. For example, the UE may observe a positive value of +1.3 or +0.5 as the given gradient of the parameter, and the UE may transmit the analog signal representing the value of +1.3 or +0.5 over the first RE. The UE may observe a negative value of −0.4 or −1.2 as the given gradient of the parameter, and the UE may transmit analog signal representing the value of +0.4 or +1.2 over the second RE. For example, at 814, the first UE 802 may transmit, in one RE of a pair of REs to the network node 804, an analog signal indicating a magnitude of the gradient value relative to the parameter of the parameters of the machine learning model. Furthermore, 1014 may be performed by the federated ML parameter reporting component 198.

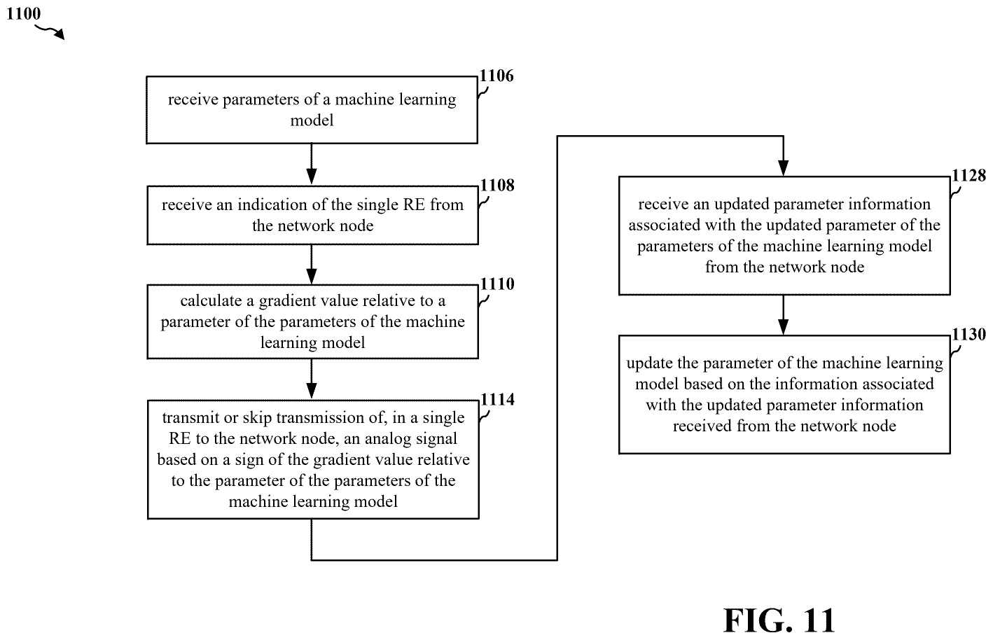

FIG. 11 is a flowchart 1100 of a method of wireless communication. The method may be performed by a UE (e.g., the UE 104; the apparatus 1704). The UE may be configured with a single RE designated for the UE to transmit an analog signal in the single RE to indicate gradient value relative to a parameter to a network node. The UE may transmit the analog signal representing the gradient value of the parameter in the single RE, receive information associated with an updated parameter information from the network node, and update the parameter of the machine learning model based on the updated parameter information received from the network node.

At 1106, the UE may receive parameters of a machine learning model from the network node. Here, the parameters of the machine learning model may be a global parameter of the machine learning model, which may be shared by the plurality of UEs including the UE. For example, at 806, the first UE 802 may receive parameters of a machine learning model from the network node 804. Furthermore, 1106 may be performed by a federated ML parameter reporting component 198.

At 1108, the UE may receive an indication of a single RE from the network node 804, the single RE being configured for the plurality of UEs including the UE to indicate the gradient value relative to the parameter of the parameters of the machine learning model. the indication may configure a single RE for the plurality of UEs including the UE. Here, the single RE may be designated for indicating the positive gradient value or the negative gradient value of the gradient value relative to the parameter of the parameters of the machine learning model. For example, at 808, the first UE 802 may receive an indication of a single RE from the network node 804. Furthermore, 1108 may be performed by the federated ML parameter reporting component 198.

At 1110, the UE may calculate a gradient value relative to a parameter of the parameters of the machine learning model. Here, the gradient value may include a positive gradient value or a negative gradient value. The UE may perform the training of the parameter of the parameters received at 1106 separately from other UEs, and calculate the gradient value of the parameter based on the training of the parameter using a training data set. For example, at 810, the first UE 802 may calculate a gradient value relative to a parameter of the parameters of the machine learning model. Furthermore, 1110 may be performed by the federated ML parameter reporting component 198.

At 1114, the UE may transmit or skip transmission of, in a single RE to the network node, an analog signal based on a sign of the gradient value relative to the parameter of the parameters of the machine learning model. The single RE may be designated for indicating the sign of the gradient value relative to the parameter of the parameters of the machine learning model as configured by the indication received from the network node at 1108. Here, a presence of the analog signal in the single RE may indicate that the sign of the gradient value is positive, and an absence of the analog signal in the RE may indicate that the sign of the gradient value is negative. For example, for the positive gradient values, e.g., 1.3 or 0.5, the UE may transmit the analog signal representing a value of +1 in the positive sign RE to indicate that the sign of the gradient value is positive, and for the negative gradient values, e.g., −0.4 or −1.2, the UE may defer transmitting the analog signal in the positive sign RE to indicate that the sign of the gradient value is negative. For example, at 814, the first UE 802 may transmit or skip transmission of, in a single RE to the network node 804, an analog signal based on a sign of the gradient value relative to the parameter of the parameters of the machine learning model. Furthermore, 1114 may be performed by the federated ML parameter reporting component 198.

At 1128, the UE may receive information associated with the updated parameter of the parameters of the machine learning model from the network node, the information associated with the updated parameter based at least in part on the analog signal transmitted to the network node. The updated parameter information may indicate an updated value of the parameter or a gradient value of the parameter. For example, at 826, the first UE 802 may receive information associated with the updated parameter of the parameters of the machine learning model from the network node 804, the information associated with the updated parameter based at least in part on the analog signal transmitted to the network node 804. Furthermore, 1126 may be performed by the federated ML parameter reporting component 198.

At 1130, the UE may update the parameter of the machine learning model based on the information associated with the updated parameter received from the network node at 1128. The information associated with the update parameter information may indicate the updated parameter (e.g., the updated global parameter) for the plurality of UEs including the UE, and the UE may replace the original parameter with the updated parameter from the information associated with the update parameter received from the network node. For example, at 830, the first UE 802 may update the parameter of the machine learning model based on the information associated with the updated parameter received from the network node 804. Furthermore, 1128 may be performed by the federated ML parameter reporting component 198.

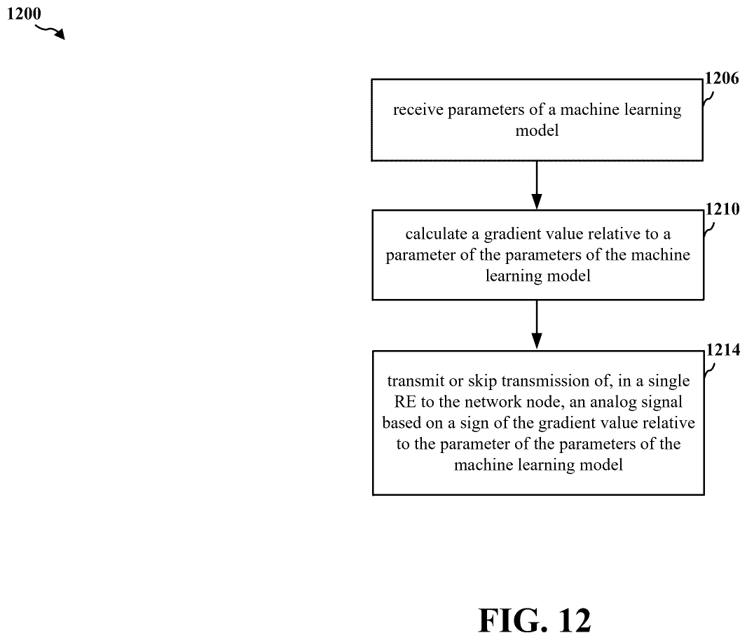

FIG. 12 is a flowchart 1200 of a method of wireless communication. The method may be performed by a UE (e.g., the UE 104; the apparatus 1704). The UE may be configured with a single RE designated for the UE to transmit an analog signal in the single RE to indicate gradient value relative to a parameter to a network node. The UE may transmit the analog signal representing the gradient value of the parameter in the single RE, receive information associated with an updated parameter information from the network node, and update the parameter of the machine learning model based on the updated parameter information received from the network node.

At 1206, the UE may receive parameters of a machine learning model from the network node. Here, the parameters of the machine learning model may be a global parameter of the machine learning model, which may be shared by the plurality of UEs including the UE. For example, at 806, the first UE 802 may receive parameters of a machine learning model from the network node 804. Furthermore, 1206 may be performed by a federated ML parameter reporting component 198.

At 1210, the UE may calculate a gradient value relative to a parameter of the parameters of the machine learning model. Here, the gradient value may include a positive gradient value or a negative gradient value. The UE may perform the training of the parameter of the parameters received at 1206 separately from other UEs, and calculate the gradient value of the parameter based on the training of the parameter using a training data set. For example, at 810, the first UE 802 may calculate a gradient value relative to a parameter of the parameters of the machine learning model. Furthermore, 1210 may be performed by the federated ML parameter reporting component 198.

At 1214, the UE may transmit or skip transmission of, in a single RE to the network node, an analog signal based on a sign of the gradient value relative to the parameter of the parameters of the machine learning model. The single RE may be designated for indicating the sign of the gradient value relative to the parameter of the parameters of the machine learning model as configured by the indication received from the network node at 1208. Here, a presence of the analog signal in the single RE may indicate that the sign of the gradient value is positive, and an absence of the analog signal in the RE may indicate that the sign of the gradient value is negative. For example, for the positive gradient values, e.g., 1.3 or 0.5, the UE may transmit the analog signal representing a value of +1 in the positive sign RE to indicate that the sign of the gradient value is positive, and for the negative gradient values, e.g., −0.4 or −1.2, the UE may defer transmitting the analog signal in the positive sign RE to indicate that the sign of the gradient value is negative. For example, at 814, the first UE 802 may transmit or skip transmission of, in a single RE to the network node 804, an analog signal based on a sign of the gradient value relative to the parameter of the parameters of the machine learning model. Furthermore, 1214 may be performed by the federated ML parameter reporting component 198.

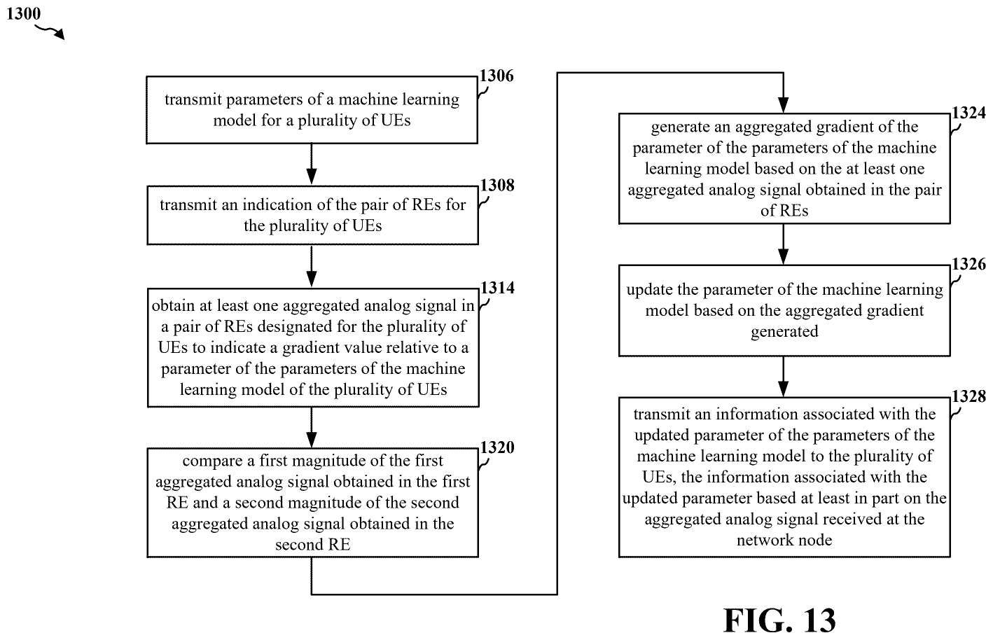

FIG. 13 is a flowchart 1300 of a method of wireless communication. The method may be performed by a base station (e.g., the base station 102; the network entity 1802/1960). The network node may configure a pair of REs for a plurality of UEs including a UE, the pair of REs being designated for the plurality of UEs to transmit a plurality of analog signals to indicate gradient value relative to a parameter to the network node. The network node may obtain at least one aggregated analog signal representing the plurality of analog signals, generate an aggregated gradient of the parameter based on the obtained at least one aggregated analog signal, and update the parameter based on the aggregated gradient. The network node may transmit information associated with the updated parameter of the machine learning model to the plurality of UEs including the UE and update the parameter of the machine learning model based on the updated parameter information.

At 1306, the network node may transmit parameters of a machine learning model for the plurality of UEs. Here, the parameters of the machine learning model may be a global parameter of the machine learning model, which may be shared by the plurality of UEs including the UE. For example, at 806, the network node 804 may transmit parameters of a machine learning model for the plurality of UEs including the first UE 802 and the second UE 803. Furthermore, 1306 may be performed by a federated ML parameter processing component 199.

At 1308, the network node may transmit an indication of a pair of REs to the plurality of UEs including the UE to configure the plurality of UEs to indicate the gradient value relative to the parameter of the parameters of the machine learning model. The indication may configure a pair of REs for the plurality of UEs. The pair of REs designated for indicating the parameters of the machine learning model may include a first RE designated for indicating the positive gradient value, and a second RE designated for indicating the negative gradient value. For example, at 808, the network node 804 may transmit an indication of a pair of REs to the plurality of UEs including the first UE 802 and the second UE 803 to configure the first UE 802 and the second UE 803 to indicate the gradient value relative to the parameter of the parameters of the machine learning model. Furthermore, 1308 may be performed by the federated ML parameter processing component 199.

At 1314, the network node may obtain at least one aggregated analog signal in a pair of REs designated for the plurality of UEs to indicate a gradient value relative to a parameter of the parameters of the machine learning model of the plurality of UEs. The aggregated analog signal obtained may represent a plurality of analog signals accumulatively obtained from the plurality of UEs at the network node. Here, each analog signal of the plurality of analog signals may indicate the gradient value relative to the parameter of the parameters of the machine learning model calculated at corresponding UE of the plurality of UEs. The at least one aggregated analog signal obtained in the pair of REs may represent a plurality of analog signals accumulatively obtained from the plurality of UEs at the network node, each analog signal of the plurality of analog signals indicating the gradient value relative to the parameter of the parameters of the machine learning model calculated at corresponding UE of the plurality of UEs. The gradient value may include a positive gradient value or a negative gradient value. The at least one aggregated analog signal may include a first aggregated analog signal and a second aggregated analog signal, and the pair of REs designated for indicating the parameter of the parameters of the machine learning model may include a first RE and a second RE. The first aggregated analog signal obtained in the first RE may represent a first set of analog signals accumulatively obtained at the network node, each analog signal of the first set of analog signals indicating the positive gradient value, and the second aggregated analog signal obtained in the second RE may represent a second set of analog signals accumulatively obtained at the network node, each analog signal of the second set of analog signals indicating the negative gradient value. For example, the first aggregated analog signal obtained in the first RE may be represented as

$${y}_{+} = {\sum }_{{n}_{+} = 1}^{{N}_{+}} \vert {g}_{{n}_{+}} \vert {e}^{i {ϕ}_{{n}_{+}}} ,$$

where N₊ may represent the number of UEs with the positive gradient value, |gₙ₊| may represent the magnitude of the positive-computed gradient value, and ϕₙ₊ may represent the arbitrary phase experienced by the UE with index n due to time-phase-frequency errors, and the second aggregated analog signal obtained in the second RE may be represented as

$${y}_{-} = {\sum }_{{n}_{-} = 1}^{{N}_{-}} \vert {g}_{{n}_{-}} \vert {e}^{i {ϕ}_{{n}_{-}}} ,$$

where N₋ may represent the number of UEs with the negative gradient value, |gₙ₋| may represent the magnitude of the positive-computed gradient value, and ϕₙ₋ may represent the arbitrary phase experienced by the UE with index n₋ due to time-phase-frequency errors. For example, at 814, the network node 804 may obtain at least one aggregated analog signal in a pair of REs designated for the plurality of UEs to indicate a gradient value relative to a parameter of the parameters of the machine learning model of the plurality of UEs. Furthermore, 1314 may be performed by the federated ML parameter processing component 199.

At 1320, the network node may compare a first magnitude of the first aggregated analog signal obtained in the first RE and a second magnitude of the second aggregated analog signal obtained in the second RE. That is, the network node may compare the |y₊|² and the |y₋|², and determine the aggregated gradient value based on the comparison of the |y₊|² and the |y₋|². For example, at 820, the network node 804 may compare a first magnitude of the first aggregated analog signal obtained in the first RE and a second magnitude of the second aggregated analog signal obtained in the second RE. Furthermore, 1320 may be performed by the federated ML parameter processing component 199.

At 1324, the network node may generate an aggregated gradient of the parameter of the parameters of the machine learning model based on the at least one aggregated analog signal obtained in the pair of REs. The aggregated gradient of the parameter of the parameters of the machine learning model may be generated based on a comparison of the first magnitude and the second magnitude at 1320. The aggregated gradient may have a value of +p based on the first magnitude being greater than the second magnitude and the aggregated gradient may have a value of −p based on the first magnitude being smaller than or equal to the second magnitude, where the p being a real number. For example, p may be +1. In one example, the network node may declare that the aggregated gradient value is +1 based on determining that |y₊|²>|y₋|². In another example, the server may declare that the aggregated gradient value is −1 based on determining that |y₊|²≤|y₋|². For example, at 824, the network node 804 may generate an aggregated gradient of the parameter of the parameters of the machine learning model based on the at least one aggregated analog signal obtained in the pair of REs. Furthermore, 1324 may be performed by the federated ML parameter processing component 199.

At 1326, the network node may update the parameter of the machine learning model based on the aggregated gradient generated at 1324. The network node may use the aggregated gradient value generated at 1324 to update the parameter of the machine learning model. For example, at 830, the network node 804 may update the parameter of the machine learning model based on the aggregated gradient generated at 824. Furthermore, 1330 may be performed by the federated ML parameter processing component 199.

At 1328, the network node may transmit information associated with the updated parameter of the parameters of the machine learning model to the plurality of UEs, the information associated with the updated parameter based at least in part on the aggregated analog signal received at the network node. The first UE may receive information associated with the updated parameter of the parameters of the machine learning model from the network node, the information associated with the updated parameter based at least in part on the analog signal transmitted to the network node. The updated parameter information may include the updated parameter at 1326. For example, at 826, the network node 804 may transmit information associated with the updated parameter of the parameters of the machine learning model to the plurality of UEs including the first UE 802 and the second UE 803, the information associated with the updated parameter based at least in part on the aggregated analog signal received at the network node 804. Furthermore, 1326 may be performed by the federated ML parameter processing component 199.

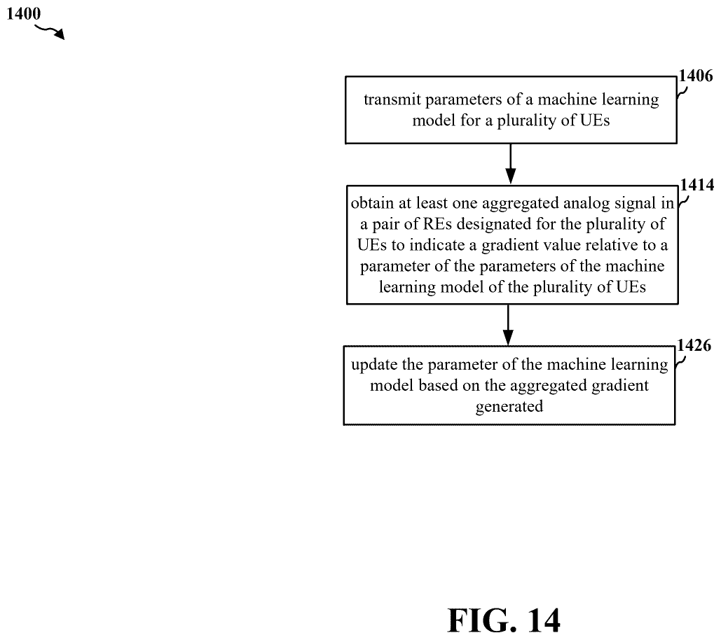

FIG. 14 is a flowchart 1400 of a method of wireless communication. The method may be performed by a base station (e.g., the base station 102; the network entity 1802/1960). The network node may configure a pair of REs for a plurality of UEs including a UE, the pair of REs being designated for the plurality of UEs to transmit a plurality of analog signals to indicate gradient value relative to a parameter to the network node. The network node may obtain at least one aggregated analog signal representing the plurality of analog signals, generate an aggregated gradient of the parameter based on the obtained at least one aggregated analog signal, and update the parameter based on the aggregated gradient. The network node may transmit information associated with the updated parameter of the machine learning model to the plurality of UEs including the UE and update the parameter of the machine learning model based on the updated parameter information.

At 1406, the network node may transmit parameters of a machine learning model for the plurality of UEs. Here, the parameters of the machine learning model may be a global parameter of the machine learning model, which may be shared by the plurality of UEs including the UE. For example, at 806, the network node 804 may transmit parameters of a machine learning model for the plurality of UEs including the first UE 802 and the second UE 803. Furthermore, 1406 may be performed by a federated ML parameter processing component 199.

At 1414, the network node may obtain at least one aggregated analog signal in a pair of REs designated for the plurality of UEs to indicate a gradient value relative to a parameter of the parameters of the machine learning model of the plurality of UEs. The aggregated analog signal obtained may represent a plurality of analog signals accumulatively obtained from the plurality of UEs at the network node. Here, each analog signal of the plurality of analog signals may indicate the gradient value relative to the parameter of the parameters of the machine learning model calculated at corresponding UE of the plurality of UEs. The at least one aggregated analog signal obtained in the pair of REs may represent a plurality of analog signals accumulatively obtained from the plurality of UEs at the network node, each analog signal of the plurality of analog signals indicating the gradient value relative to the parameter of the parameters of the machine learning model calculated at corresponding UE of the plurality of UEs. The gradient value may include a positive gradient value or a negative gradient value. The at least one aggregated analog signal may include a first aggregated analog signal and a second aggregated analog signal, and the pair of REs designated for indicating the parameter of the parameters of the machine learning model may include a first RE and a second RE. The first aggregated analog signal obtained in the first RE may represent a first set of analog signals accumulatively obtained at the network node, each analog signal of the first set of analog signals indicating the positive gradient value, and the second aggregated analog signal obtained in the second RE may represent a second set of analog signals accumulatively obtained at the network node, each analog signal of the second set of analog signals indicating the negative gradient value. For example, the first aggregated analog signal obtained in the first RE may be represented as

$${y}_{+} = {\sum }_{{n}_{+} = 1}^{{N}_{+}} \vert {g}_{{n}_{+}} \vert {e}^{i {ϕ}_{{n}_{+}}} ,$$

where N₊ may represent the number of UEs with the positive gradient value, |gₙ₊| may represent the magnitude of the positive-computed gradient value, and ϕₙ₊ may represent the arbitrary phase experienced by the UE with index n due to time-phase-frequency errors, and the second aggregated analog signal obtained in the second RE may be represented as

$${y}_{-} = {\sum }_{{n}_{-} = 1}^{{N}_{-}} \vert {g}_{{n}_{-}} \vert {e}^{i {ϕ}_{{n}_{-}}} ,$$

where N₋ may represent the number of UEs with the negative gradient value, |gₙ₋| may represent the magnitude of the positive-computed gradient value, and ϕₙ₋ may represent the arbitrary phase experienced by the UE with index n₋ due to time-phase-frequency errors. For example, at 814, the network node 804 may obtain at least one aggregated analog signal in a pair of REs designated for the plurality of UEs to indicate a gradient value relative to a parameter of the parameters of the machine learning model of the plurality of UEs. Furthermore, 1414 may be performed by the federated ML parameter processing component 199.

At 1426, the network node may update the parameter of the machine learning model based on the aggregated gradient generated at 1424. The network node may use the aggregated gradient value generated at 1424 to update the parameter of the machine learning model. For example, at 830, the network node 804 may update the parameter of the machine learning model based on the aggregated gradient generated at 824. Furthermore, 1430 may be performed by the federated ML parameter processing component 199.

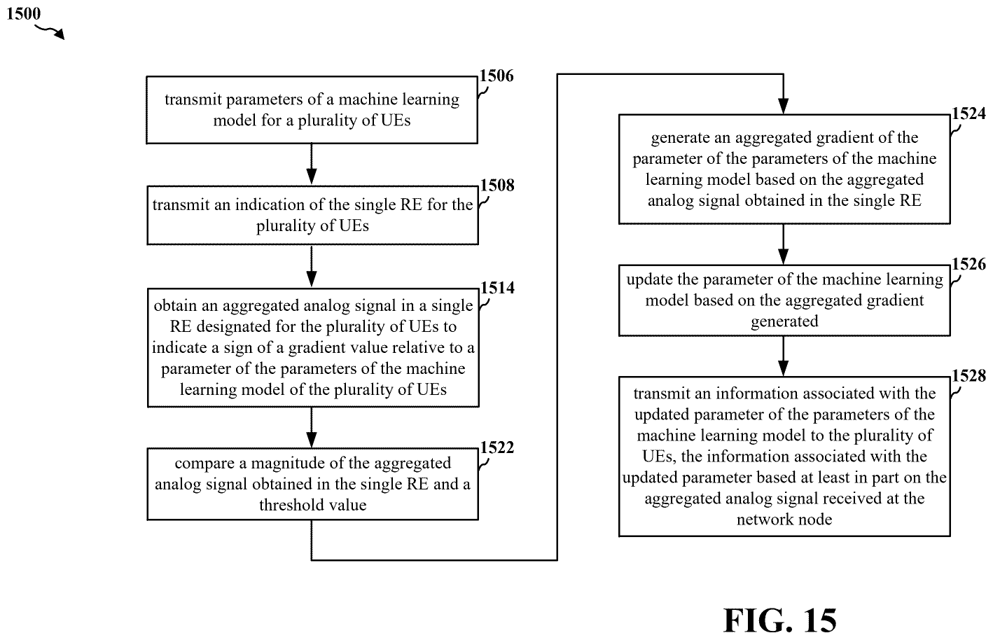

FIG. 15 is a flowchart 1500 of a method of wireless communication. The method may be performed by a base station (e.g., the base station 102; the network entity 1802/1960). The network node may configure a single RE for a plurality of UEs including a UE, the single RE being designated for the plurality of UEs to transmit a plurality of analog signals to indicate gradient value relative to a parameter to the network node. The network node may obtain at least one aggregated analog signal representing the plurality of analog signals, generate an aggregated gradient of the parameter based on the obtained at least one aggregated analog signal, and update the parameter based on the aggregated gradient. The network node may transmit information associated with the updated parameter of the machine learning model to the plurality of UEs including the UE and update the parameter of the machine learning model based on the updated parameter information.

At 1506, the network node may transmit parameters of a machine learning model for the plurality of UEs. Here, the parameters of the machine learning model may be a global parameter of the machine learning model, which may be shared by the plurality of UEs including the UE. For example, at 806, the network node 804 may transmit parameters of a machine learning model for the plurality of UEs including the first UE 802 and the second UE 803. Furthermore, 1506 may be performed by a federated ML parameter processing component 199.

At 1508, the network node may transmit an indication of a single RE to the plurality of UEs including the UE to configure the plurality of UEs to indicate the gradient value relative to the parameter of the parameters of the machine learning model. The indication may configure a single RE for the plurality of UEs. Here, the single RE may be designated for indicating the positive gradient value or the negative gradient value of the gradient value relative to the parameter of the parameters of the machine learning model. For example, at 808, the network node 804 may transmit an indication of a single RE to the plurality of UEs including the first UE 802 and the second UE 803 to configure the first UE 802 and the second UE 803 to indicate the gradient value relative to the parameter of the parameters of the machine learning model. Furthermore, 1508 may be performed by the federated ML parameter processing component 199.

At 1514, the network node may obtain an aggregated analog signal in a single RE designated for the plurality of UEs to indicate a sign of a gradient value relative to a parameter of the parameters of the machine learning model of the plurality of UEs. The aggregated analog signal obtained may represent a plurality of analog signals accumulatively obtained from the plurality of UEs at the network node. Here, each analog signal of the plurality of analog signals may indicate the sign of the gradient value relative to the parameter of the parameters of the machine learning model calculated at corresponding UE of the plurality of UEs. The aggregated analog signal obtained in the single RE representing a plurality of analog signals accumulatively obtained from the plurality of UEs at the network node. Each analog signal of the plurality of analog signals may indicate that the sign of the gradient value relative to the parameter of the parameters of the machine learning model calculated at corresponding UE of the plurality of UEs is one of positive or negative. Here, at least one aggregated analog signal is obtained in the single RE based on the indication of the single RE. For example, the aggregated analog signal obtained in the single RE may be represented as

$${y}_{+} = {\sum }_{{n}_{+} = 1}^{{N}_{+}} \vert {g}_{{n}_{+}} \vert {e}^{i {ϕ}_{{n}_{+}}} ,$$

where N₊ may represent the number of UEs with the positive gradient value, |gₙ₊| may represent the magnitude of the positive-computed gradient value, and ϕₙ₊ may represent the arbitrary phase experienced by the UE with index n due to time-phase-frequency errors. For example, at 814, the network node 804 may obtain an aggregated analog signal in a single RE designated for the plurality of UEs to indicate a gradient value relative to a parameter of the parameters of the machine learning model of the plurality of UEs. Furthermore, 1514 may be performed by the federated ML parameter processing component 199.

At 1522, the network node may compare a magnitude of the aggregated analog signal obtained in the single RE and a threshold value. That is, the network node may compare the |y₊|² and the threshold value, and determine the aggregated gradient value based on the comparison of the |y₊|² and the threshold value. Here, the threshold value may be determined or configured by the network node. For example, at 822, the network node 804 may compare a magnitude of the aggregated analog signal obtained in the single RE and a threshold value. Furthermore, 1522 may be performed by the federated ML parameter processing component 199.

At 1524, the network node may generate an aggregated gradient of the parameter of the parameters of the machine learning model based on the aggregated analog signal obtained in the single RE. The aggregated gradient of the parameter of the parameters of the machine learning model may be generated based on a comparison of the magnitude of the aggregated analog signal and the threshold value determined at 1522. The aggregated gradient may have a value of +p based on the magnitude being greater than the threshold value, and the aggregated gradient may have a value of −p based on the magnitude being smaller than or equal to the threshold value, where p is a real number. For example, p may be +1. In one example, the network node may declare that the aggregated gradient value is +1 based on determining that the |y₊|²>threshold value. In another example, the network node may declare that the aggregated gradient value is −1 based on determining that |y₊|²≤threshold value. Here, the threshold value may be determined or configured by the network node. For example, at 824, the network node 804 may generate an aggregated gradient of the parameter of the parameters of the machine learning model based on the aggregated analog signal obtained in the single RE. Furthermore, 1524 may be performed by the federated ML parameter processing component 199.

At 1526, the network node may update the parameter of the machine learning model based on the aggregated gradient generated at 1524. The network node may use the aggregated gradient value generated at 1324 to update the parameter of the machine learning model. For example, at 830, the network node 804 may update the parameter of the machine learning model based on the aggregated gradient generated at 824. Furthermore, 1530 may be performed by the federated ML parameter processing component 199.

At 1528, the network node may transmit information associated with the updated parameter of the parameters of the machine learning model to the plurality of UEs, the information associated with the updated parameter based at least in part on the aggregated analog signal received at the network node. The first UE may receive information associated with the updated parameter of the parameters of the machine learning model from the network node, the information associated with the updated parameter based at least in part on the analog signal transmitted to the network node. The updated parameter information may include the updated parameter at 1526. For example, at 826, the network node 804 may transmit information associated with the updated parameter of the parameters of the machine learning model to the plurality of UEs including the first UE 802 and the second UE 803, the information associated with the updated parameter based at least in part on the aggregated analog signal received at the network node 804. Furthermore, 1526 may be performed by the federated ML parameter processing component 199.

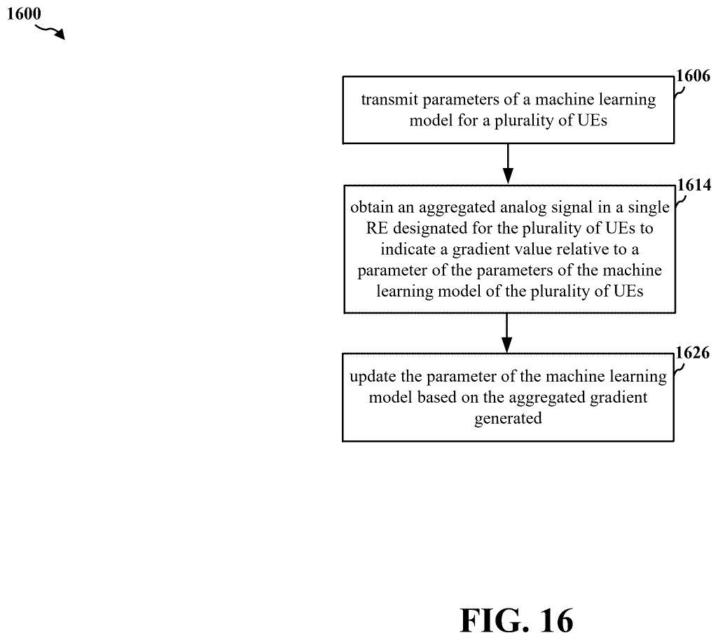

FIG. 16 is a flowchart 1600 of a method of wireless communication. The method may be performed by a base station (e.g., the base station 102; the network entity 1802/1960). The network node may configure a single RE for a plurality of UEs including a UE, the single RE being designated for the plurality of UEs to transmit a plurality of analog signals to indicate gradient value relative to a parameter to the network node. The network node may obtain at least one aggregated analog signal representing the plurality of analog signals, generate an aggregated gradient of the parameter based on the obtained at least one aggregated analog signal, and update the parameter based on the aggregated gradient. The network node may transmit information associated with the updated parameter of the machine learning model to the plurality of UEs including the UE and update the parameter of the machine learning model based on the updated parameter information.

At 1606, the network node may transmit parameters of a machine learning model for the plurality of UEs. Here, the parameters of the machine learning model may be a global parameter of the machine learning model, which may be shared by the plurality of UEs including the UE. For example, at 806, the network node 804 may transmit parameters of a machine learning model for the plurality of UEs including the first UE 802 and the second UE 803. Furthermore, 1606 may be performed by a federated ML parameter processing component 199.

At 1614, the network node may obtain an aggregated analog signal in a single RE designated for the plurality of UEs to indicate a sign of a gradient value relative to a parameter of the parameters of the machine learning model of the plurality of UEs. The aggregated analog signal obtained may represent a plurality of analog signals accumulatively obtained from the plurality of UEs at the network node. Here, each analog signal of the plurality of analog signals may indicate the sign of the gradient value relative to the parameter of the parameters of the machine learning model calculated at corresponding UE of the plurality of UEs. The aggregated analog signal obtained in the single RE representing a plurality of analog signals accumulatively obtained from the plurality of UEs at the network node. Each analog signal of the plurality of analog signals may indicate that the sign of the gradient value relative to the parameter of the parameters of the machine learning model calculated at corresponding UE of the plurality of UEs is one of positive or negative. Here, at least one aggregated analog signal is obtained in the single RE based on the indication of the single RE. For example, the aggregated analog signal obtained in the single RE may be represented as

$${y}_{+} = {\sum }_{{n}_{+} = 1}^{{N}_{+}} \vert {g}_{{n}_{+}} \vert {e}^{i {ϕ}_{{n}_{+}}} ,$$

where N₊ may represent the number of UEs with the positive gradient value, |gₙ₊| may represent the magnitude of the positive-computed gradient value, and ϕₙ₊ may represent the arbitrary phase experienced by the UE with index n due to time-phase-frequency errors. For example, at 814, the network node 804 may obtain an aggregated analog signal in a single RE designated for the plurality of UEs to indicate a gradient value relative to a parameter of the parameters of the machine learning model of the plurality of UEs. Furthermore, 1614 may be performed by the federated ML parameter processing component 199.

At 1626, the network node may update the parameter of the machine learning model based on the aggregated gradient generated at 1624. The network node may use the aggregated gradient value generated at 1324 to update the parameter of the machine learning model. For example, at 830, the network node 804 may update the parameter of the machine learning model based on the aggregated gradient generated at 824. Furthermore, 1630 may be performed by the federated ML parameter processing component 199.

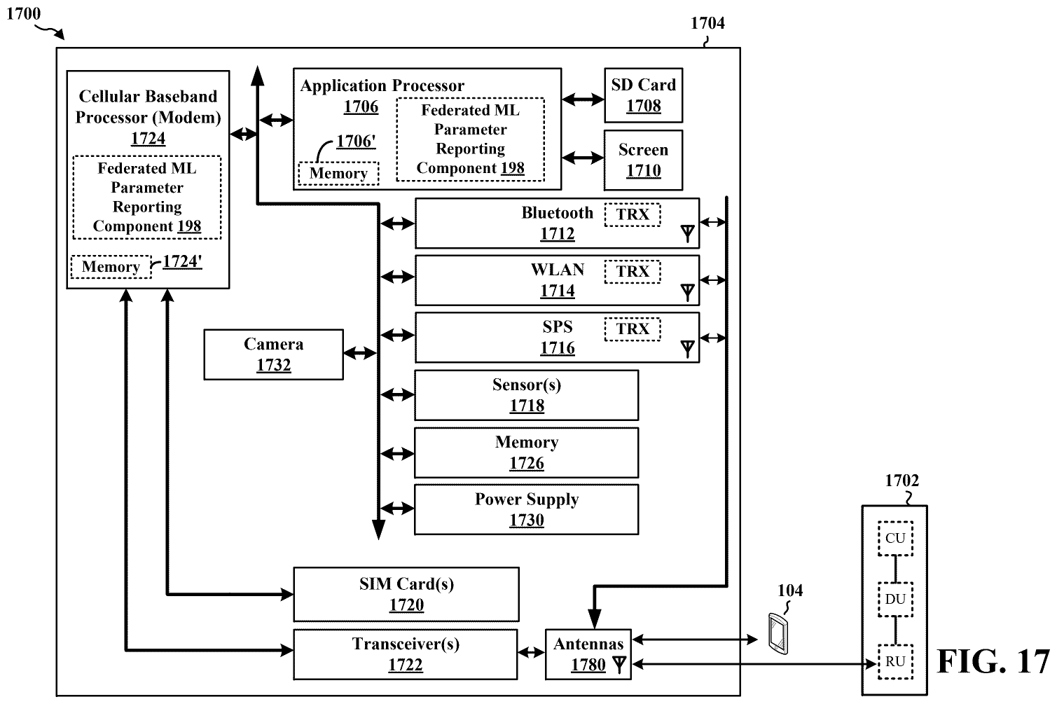

FIG. 17 is a diagram 1700 illustrating an example of a hardware implementation for an apparatus 1704. The apparatus 1704 may be a UE, a component of a UE, or may implement UE functionality. In some aspects, the apparatus 1304 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see 350 of FIG. 3) and include the additional modules of the apparatus 1704.

As discussed supra, the federated ML parameter reporting component 198 is configured to receive parameters of a machine learning model from a network node, calculate a gradient value relative to a parameter of the parameters of the machine learning model, the gradient value including a positive gradient value or a negative gradient value, and transmit, in one RE of a pair of REs to the network node, an analog signal indicating a magnitude of the gradient value relative to the parameter of the parameters of the machine learning model, the pair of REs designated for indicating the gradient value relative to the parameter of the parameters of the machine learning model. The federated ML parameter reporting component 198 is also configured to receive parameters of a machine learning model from a network node, calculate a gradient value relative to a parameter of the parameters of the machine learning model, a sign of the gradient value being one of positive or negative, and transmit or skip transmission of, in a single RE to the network node, an analog signal based on the sign of the gradient value relative to the parameter of the parameters of the machine learning model, the single RE designated for indicating the sign of the gradient value relative to the parameter of the parameters of the machine learning model. The federated ML parameter reporting component 198 may be within the cellular baseband processor 1724, the application processor 1706, or both the cellular baseband processor 1724 and the application processor 1706. The federated ML parameter reporting component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, includes means for receiving parameters of a machine learning model from a network node, means for calculating a gradient value relative to a parameter of the parameters of the machine learning model, the gradient value including a positive gradient value or a negative gradient value, and means for transmitting, in one RE of a pair of REs to the network node, an analog signal indicating a magnitude of the gradient value relative to the parameter of the parameters of the machine learning model, the pair of REs designated for indicating the gradient value relative to the parameter of the parameters of the machine learning model. In one configuration, the pair of REs designated for indicating the parameters of the machine learning model includes a first RE designated for indicating the positive gradient value, and a second RE designated for indicating the negative gradient value, where the analog signal is transmitted in the first RE or the second RE based on the gradient value. In one configuration, the apparatus 1704, and in particular the cellular baseband processor 1724 and/or the application processor 1706, further includes means for receiving an information associated with an updated parameter of the machine learning model from the network node, the updated parameter based at least in part on the analog signal transmitted to the network node, and means for updating the parameter of the machine learning model based on the information associated with the updated parameter received from the network node. In one configuration, the information associated with the updated parameter includes the updated parameter based at least in part on the analog signal transmitted to the network node. In one configuration, the apparatus 1704, and in particular the cellular baseband processor 1724 and/or the application processor 1706, further includes means for receiving an indication of the pair of REs from the network node, where the analog signal is transmitted in the one RE of the pair of REs based on the indication of the pair of REs received from the network node. In one configuration, the apparatus 1704, and in particular the cellular baseband processor 1724 and/or the application processor 1706, includes means for receiving parameters of a machine learning model from a network node, means for calculating a gradient value relative to a parameter of the parameters of the machine learning model, a sign of the gradient value being one of positive or negative, and means for transmitting or skipping transmission of, in a single RE to the network node, an analog signal based on the sign of the gradient value relative to the parameter of the parameters of the machine learning model, the single RE designated for indicating the sign of the gradient value relative to the parameter of the parameters of the machine learning model. In one configuration, a presence of the analog signal in the single RE indicates that the sign of the gradient value is positive, and an absence of the analog signal in the RE indicates that the sign of the gradient value is negative. In one configuration, the apparatus 1704, and in particular the cellular baseband processor 1724 and/or the application processor 1706, further includes means for receiving an information associated with an updated parameter of the machine learning model from the network node, the updated parameter based at least in part on the analog signal transmitted to the network node, and means for updating the parameter of the machine learning model based on the information associated with the updated parameter received from the network node. In one configuration, the information associated with the updated parameter includes the updated parameter based at least in part on the analog signal transmitted to the network node. In one configuration, the apparatus 1704, and in particular the cellular baseband processor 1724 and/or the application processor 1706, further includes means for receiving an indication of the single RE from the network node, where the analog signal is transmitted in the single RE based on the indication of the single RE received from the network node. The means may be the federated ML parameter reporting component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

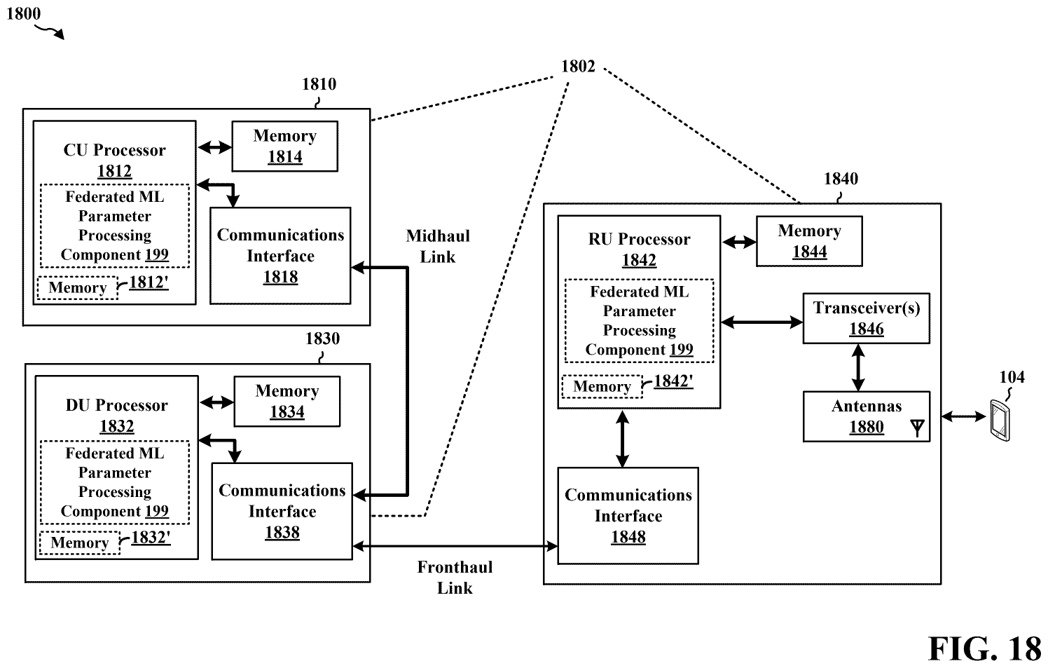

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the federated ML parameter processing component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the federated ML parameter processing component 199 is configured to output for transmission parameters of a machine learning model for a plurality of UEs, obtain at least one aggregated analog signal in a pair of REs designated for the plurality of UEs to indicate a gradient value relative to a parameter of the parameters of the machine learning model of the plurality of UEs, the at least one aggregated analog signal obtained in the pair of REs representing a plurality of analog signals accumulatively obtained from the plurality of UEs at the network node, each analog signal of the plurality of analog signals indicating the gradient value relative to the parameter of the parameters of the machine learning model calculated at corresponding UE of the plurality of UEs, the gradient value including a positive gradient value or a negative gradient value, and update the parameter of the parameters of the machine learning model based on the at least one aggregated analog signal obtained in the pair of REs. The federated ML parameter processing component 199 is also configured to output for transmission parameters of a machine learning model for a plurality of UEs, obtain an aggregated analog signal in a single RE designated for the plurality of UEs to indicate a sign of a gradient value relative to a parameter of the parameters of the machine learning model of the plurality of UEs, the aggregated analog signal obtained in the single RE representing a plurality of analog signals accumulatively obtained from the plurality of UEs at the network node, each analog signal of the plurality of analog signals indicating that the sign of the gradient value relative to the parameter of the parameters of the machine learning model calculated at corresponding UE of the plurality of UEs is one of positive or negative, and update the parameter of the parameters of the machine learning model based on the aggregated analog signal obtained in the single RE. The federated ML parameter processing component 199 may be within one or more processors of one or more of the CU 1810, DU 1830, and the RU 1840. The federated ML parameter processing component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 includes means for outputting for transmission parameters of a machine learning model for a plurality of UEs, means for obtaining at least one aggregated analog signal in a pair of REs designated for the plurality of UEs to indicate a gradient value relative to a parameter of the parameters of the machine learning model of the plurality of UEs, the at least one aggregated analog signal obtained in the pair of REs representing a plurality of analog signals accumulatively obtained from the plurality of UEs at the network node, each analog signal of the plurality of analog signals indicating the gradient value relative to the parameter of the parameters of the machine learning model calculated at corresponding UE of the plurality of UEs, the gradient value including a positive gradient value or a negative gradient value, and means for updating the parameter of the parameters of the machine learning model based on the at least one aggregated analog signal obtained in the pair of REs. In one configuration, the at least one aggregated analog signal includes a first aggregated analog signal and a second aggregated analog signal, and the pair of REs designated for indicating the parameter of the parameters of the machine learning model includes a first RE and a second RE, the first aggregated analog signal obtained in the first RE represents a first set of analog signals accumulatively obtained at the network node, each analog signal of the first set of analog signals indicating the positive gradient value, and the second aggregated analog signal obtained in the second RE represents a second set of analog signals accumulatively obtained at the network node, each analog signal of the second set of analog signals indicating the negative gradient value. In one configuration, the network entity 1802 further includes means for comparing a first magnitude of the first aggregated analog signal obtained in the first RE and a second magnitude of the second aggregated analog signal obtained in the second RE, and where the parameter is updated based on a comparison of the first magnitude and the second magnitude. In one configuration, the network entity 1802 further includes means for generating an aggregated gradient of the parameter based on the comparison of the first magnitude and the second magnitude, where the parameter is updated based on the aggregated gradient of the parameter. In one configuration, the aggregated gradient of the parameter has a value of +p based on the first magnitude being greater than the second magnitude, the aggregated gradient of the parameter has a value of −p based on the first magnitude being smaller than or equal to the second magnitude, and the p being a real number. In one configuration, the network entity 1802 further includes means for outputting for transmission an information associated with the updated parameter of the machine learning model to plurality of UEs. In one configuration, the information associated with the updated parameter includes the updated parameter. In one configuration, the network entity 1802 further includes means for outputting for transmission an indication of the pair of REs for the plurality of UEs, and where the at least one aggregated analog signal is obtained in the pair of REs based on the indication of the pair of REs. In one configuration, the network entity 1802 includes means for outputting for transmission parameters of a machine learning model for a plurality of UEs, means for obtaining an aggregated analog signal in a single RE designated for the plurality of UEs to indicate a sign of a gradient value relative to a parameter of the parameters of the machine learning model of the plurality of UEs, the aggregated analog signal obtained in the single RE representing a plurality of analog signals accumulatively obtained from the plurality of UEs at the network node, each analog signal of the plurality of analog signals indicating that the sign of the gradient value relative to the parameter of the parameters of the machine learning model calculated at corresponding UE of the plurality of UEs is one of positive or negative, and means for updating the parameter of the parameters of the machine learning model based on the aggregated analog signal obtained in the single RE. In one configuration, a presence of the analog signal in the single RE indicates that the sign of the gradient value is, and an absence of the analog signal in the single RE indicates that the sign of the gradient value is negative. In one configuration, the network entity 1802 further includes means for comparing a magnitude of the aggregated analog signal obtained in the single RE and a threshold value, where the parameter is updated based on a comparison of the magnitude and the threshold value. In one configuration, the network entity 1802 further includes means for generating an aggregated gradient of the parameter based on the comparison of the magnitude and the threshold value, where the parameter is updated based on the aggregated gradient of the parameter. In one configuration, the aggregated gradient of the parameter has a value of +p based on the magnitude being greater than the threshold value, the aggregated gradient of the parameter has a value of −p based on the magnitude being smaller than or equal to the threshold value, and the p being a real number. In one configuration, the network entity 1802 further includes means for outputting for transmission an information associated with the updated parameter of the machine learning model to plurality of UEs. In one configuration, the information associated with the updated parameter includes the updated parameter. In one configuration, the network entity 1802 further includes means for outputting for transmission an indication of the single RE for the plurality of UEs, where the at least one aggregated analog signal is obtained in the single RE based on the indication of the single RE. The means may be the federated ML parameter processing component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

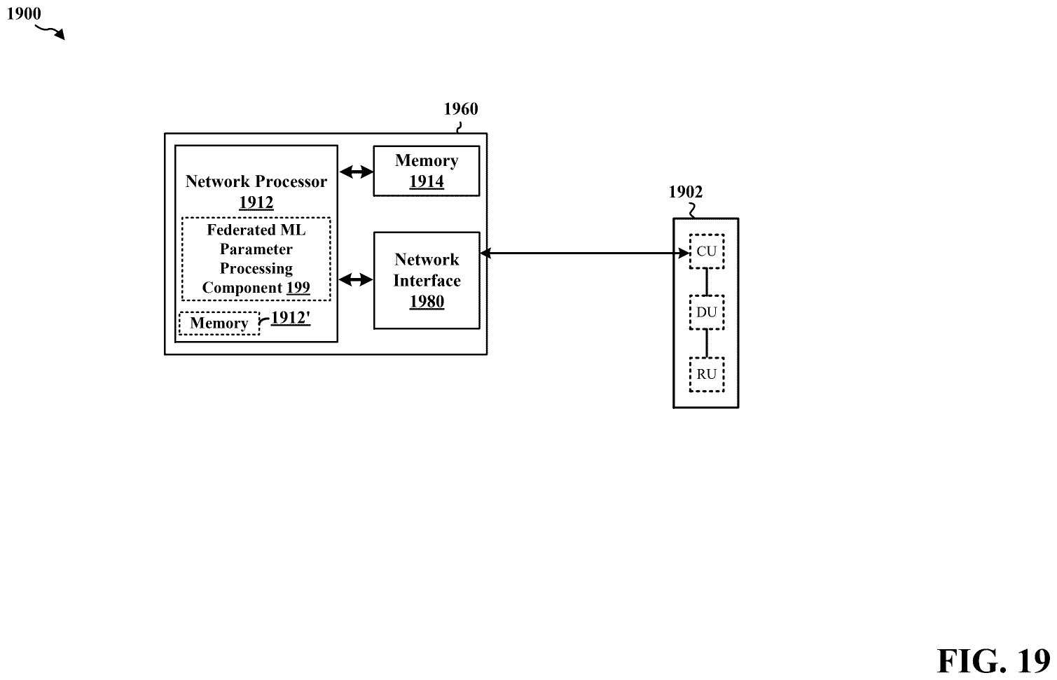

FIG. 19 is a diagram 1900 illustrating an example of a hardware implementation for a network entity 1960. In one example, the network entity 1960 may be within the core network 120. The network entity 1960 may include a network processor 1912. The network processor 1912 may include on-chip memory 1912′. In some aspects, the network entity 1960 may further include additional memory modules 1914. The network entity 1960 communicates via the network interface 1980 directly (e.g., backhaul link) or indirectly (e.g., through a RIC) with the CU 1902. The on-chip memory 1912′ and the additional memory modules 1914 may each be considered a computer-readable medium/memory. Each computer-readable medium/memory may be non-transitory. The processor 1912 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the federated ML parameter processing component 199 is configured to output for transmission parameters of a machine learning model for a plurality of UEs, obtain at least one aggregated analog signal in a pair of REs designated for the plurality of UEs to indicate a gradient value relative to a parameter of the parameters of the machine learning model of the plurality of UEs, the at least one aggregated analog signal obtained in the pair of REs representing a plurality of analog signals accumulatively obtained from the plurality of UEs at the network node, each analog signal of the plurality of analog signals indicating the gradient value relative to the parameter of the parameters of the machine learning model calculated at corresponding UE of the plurality of UEs, the gradient value including a positive gradient value or a negative gradient value, and update the parameter of the parameters of the machine learning model based on the at least one aggregated analog signal obtained in the pair of REs. The federated ML parameter processing component 199 is also configured to output for transmission parameters of a machine learning model for a plurality of UEs, obtain an aggregated analog signal in a single RE designated for the plurality of UEs to indicate a sign of a gradient value relative to a parameter of the parameters of the machine learning model of the plurality of UEs, the aggregated analog signal obtained in the single RE representing a plurality of analog signals accumulatively obtained from the plurality of UEs at the network node, each analog signal of the plurality of analog signals indicating that the sign of the gradient value relative to the parameter of the parameters of the machine learning model calculated at corresponding UE of the plurality of UEs is one of positive or negative, and update the parameter of the parameters of the machine learning model based on the aggregated analog signal obtained in the single RE. The federated ML parameter processing component 199 may be within the processor 1912. The federated ML parameter processing component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1960 may include a variety of components configured for various functions. In one configuration, the network entity 1960 includes means for outputting for transmission parameters of a machine learning model for a plurality of UEs, means for obtaining at least one aggregated analog signal in a pair of REs designated for the plurality of UEs to indicate a gradient value relative to a parameter of the parameters of the machine learning model of the plurality of UEs, the at least one aggregated analog signal obtained in the pair of REs representing a plurality of analog signals accumulatively obtained from the plurality of UEs at the network node, each analog signal of the plurality of analog signals indicating the gradient value relative to the parameter of the parameters of the machine learning model calculated at corresponding UE of the plurality of UEs, the gradient value including a positive gradient value or a negative gradient value, and means for updating the parameter of the parameters of the machine learning model based on the at least one aggregated analog signal obtained in the pair of REs. In one configuration, the at least one aggregated analog signal includes a first aggregated analog signal and a second aggregated analog signal, and the pair of REs designated for indicating the parameter of the parameters of the machine learning model includes a first RE and a second RE, the first aggregated analog signal obtained in the first RE represents a first set of analog signals accumulatively obtained at the network node, each analog signal of the first set of analog signals indicating the positive gradient value, and the second aggregated analog signal obtained in the second RE represents a second set of analog signals accumulatively obtained at the network node, each analog signal of the second set of analog signals indicating the negative gradient value. In one configuration, the network entity 1960 further includes means for comparing a first magnitude of the first aggregated analog signal obtained in the first RE and a second magnitude of the second aggregated analog signal obtained in the second RE, and where the parameter is updated based on a comparison of the first magnitude and the second magnitude. In one configuration, the network entity 1960 further includes means for generating an aggregated gradient of the parameter based on the comparison of the first magnitude and the second magnitude, where the parameter is updated based on the aggregated gradient of the parameter. In one configuration, the aggregated gradient of the parameter has a value of +p based on the first magnitude being greater than the second magnitude, the aggregated gradient of the parameter has a value of −p based on the first magnitude being smaller than or equal to the second magnitude, and the p being a real number. In one configuration, the network entity 1960 further includes means for outputting for transmission an information associated with the updated parameter of the machine learning model to plurality of UEs. In one configuration, the information associated with the updated parameter includes the updated parameter. In one configuration, the network entity 1960 further includes means for outputting for transmission an indication of the pair of REs for the plurality of UEs, and where the at least one aggregated analog signal is obtained in the pair of REs based on the indication of the pair of REs. In one configuration, the network entity 1960 includes means for outputting for transmission parameters of a machine learning model for a plurality of UEs, means for obtaining an aggregated analog signal in a single RE designated for the plurality of UEs to indicate a sign of a gradient value relative to a parameter of the parameters of the machine learning model of the plurality of UEs, the aggregated analog signal obtained in the single RE representing a plurality of analog signals accumulatively obtained from the plurality of UEs at the network node, each analog signal of the plurality of analog signals indicating that the sign of the gradient value relative to the parameter of the parameters of the machine learning model calculated at corresponding UE of the plurality of UEs is one of positive or negative, and means for updating the parameter of the parameters of the machine learning model based on the aggregated analog signal obtained in the single RE. In one configuration, a presence of the analog signal in the single RE indicates that the sign of the gradient value is, and an absence of the analog signal in the single RE indicates that the sign of the gradient value is negative. In one configuration, the network entity 1960 further includes means for comparing a magnitude of the aggregated analog signal obtained in the single RE and a threshold value, where the parameter is updated based on a comparison of the magnitude and the threshold value. In one configuration, the network entity 1960 further includes means for generating an aggregated gradient of the parameter based on the comparison of the magnitude and the threshold value, where the parameter is updated based on the aggregated gradient of the parameter. In one configuration, the aggregated gradient of the parameter has a value of +p based on the magnitude being greater than the threshold value, the aggregated gradient of the parameter has a value of −p based on the magnitude being smaller than or equal to the threshold value, and the p being a real number. In one configuration, the network entity 1960 further includes means for outputting for transmission an information associated with the updated parameter of the machine learning model to plurality of UEs. In one configuration, the information associated with the updated parameter includes the updated parameter. In one configuration, the network entity 1960 further includes means for outputting for transmission an indication of the single RE for the plurality of UEs, where the at least one aggregated analog signal is obtained in the single RE based on the indication of the single RE. The means may be the federated ML parameter processing component 199 of the network entity 1960 configured to perform the functions recited by the means.

Based on some aspects of the current disclosure, a UE receives parameters of a machine learning model from a network node; calculate a gradient value relative to a parameter of the parameters of the machine learning model, the gradient value including a positive gradient value or a negative gradient value. The UE may transmit, in one RE of a pair of REs to the network node, an analog signal indicating a magnitude of the gradient value relative to the parameter of the parameters of the machine learning model. The UE may transmit or skip transmission of, in a single RE to the network node, an analog signal based on the gradient value, the single RE designated for indicating the positive gradient value or the negative gradient value of the gradient value relative to the parameter of the parameters of the machine learning model. The network node may receive at least one aggregated analog signal in the pair of REs or the single RE, and update the parameter based on the received at least one aggregated analog signal. The network node may transmit information associated with the updated parameter.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including receiving parameters of a machine learning model from a network node, calculating a gradient value relative to a parameter of the parameters of the machine learning model, the gradient value including a positive gradient value or a negative gradient value, and transmitting, in one RE of a pair of REs to the network node, an analog signal indicating a magnitude of the gradient value relative to the parameter of the parameters of the machine learning model, the pair of REs designated for indicating the gradient value relative to the parameter of the parameters of the machine learning model.

Aspect 2 is the method of aspect 1, where the pair of REs designated for indicating the parameters of the machine learning model includes a first RE designated for indicating the positive gradient value, and a second RE designated for indicating the negative gradient value, where the analog signal is transmitted in the first RE or the second RE based on the gradient val.

Aspect 3 is the method of any of aspects 1 and 2, further including receiving an information associated with an updated parameter of the machine learning model from the network node, the updated parameter based at least in part on the analog signal transmitted to the network node, and updating the parameter of the machine learning model based on the information associated with the updated parameter received from the network node.

Aspect 4 is the method of aspect 3, where the information associated with the updated parameter includes the updated parameter based at least in part on the analog signal transmitted to the network node.

Aspect 5 is the method of any of aspects 1 to 4, further including receiving an indication of the pair of REs from the network node, where the analog signal is transmitted in the one RE of the pair of REs based on the indication of the pair of REs received from the network node.

Aspect 6 is an apparatus for wireless communication including at least one processor coupled to a memory and configured to implement any of aspects 1 to 5, further including a transceiver coupled to the at least one processor.

Aspect 7 is an apparatus for wireless communication including means for implementing any of aspects 1 to 5.

Aspect 8 is a non-transitory computer-readable medium storing computer executable code, where the code when executed by a processor causes the processor to implement any of aspects 1 to 5.

Aspect 9 is a method of wireless communication at a UE, including receiving parameters of a machine learning model from a network node, calculating a gradient value relative to a parameter of the parameters of the machine learning model, a sign of the gradient value being one of positive or negative, and transmitting or skipping transmission of, in a single RE to the network node, an analog signal based on the sign of the gradient value relative to the parameter of the parameters of the machine learning model, the single RE designated for indicating the sign of the gradient value relative to the parameter of the parameters of the machine learning model.

Aspect 10 is the method of aspect 9, where a presence of the analog signal in the single RE indicates that the sign of the gradient value is positive, and an absence of the analog signal in the RE indicates that the sign of the gradient value is negative.

Aspect 11 is the method of any of aspects 9 and 10, further including receiving an information associated with an updated parameter of the machine learning model from the network node, the updated parameter based at least in part on the analog signal transmitted to the network node, and updating the parameter of the machine learning model based on the information associated with the updated parameter received from the network node.

Aspect 12 is the method of aspect 11, where the information associated with the updated parameter includes the updated parameter based at least in part on the analog signal transmitted to the network node.

Aspect 13 is the method of any of aspects 9 to 12, further including receiving an indication of the single RE from the network node, where the analog signal is transmitted in the single RE based on the indication of the single RE received from the network node.

Aspect 14 is an apparatus for wireless communication including at least one processor coupled to a memory and configured to implement any of aspects 9 to 14, further including a transceiver coupled to the at least one processor.

Aspect 15 is an apparatus for wireless communication including means for implementing any of aspects 9 to 14.

Aspect 16 is a non-transitory computer-readable medium storing computer executable code, where the code when executed by a processor causes the processor to implement any of aspects 9 to 14.

Aspect 17 is a method of wireless communication at a network node, including outputting for transmission parameters of a machine learning model for a plurality of UEs, obtaining at least one aggregated analog signal in a pair of REs designated for the plurality of UEs to indicate a gradient value relative to a parameter of the parameters of the machine learning model of the plurality of UEs, the at least one aggregated analog signal obtained in the pair of REs representing a plurality of analog signals accumulatively obtained from the plurality of UEs at the network node, each analog signal of the plurality of analog signals indicating the gradient value relative to the parameter of the parameters of the machine learning model calculated at corresponding UE of the plurality of UEs, the gradient value including a positive gradient value or a negative gradient value, and updating the parameter of the parameters of the machine learning model based on the at least one aggregated analog signal obtained in the pair of REs.

Aspect 18 is the method of aspect 17, where the at least one aggregated analog signal includes a first aggregated analog signal and a second aggregated analog signal, and the pair of REs designated for indicating the parameter of the parameters of the machine learning model includes a first RE and a second RE, the first aggregated analog signal obtained in the first RE represents a first set of analog signals accumulatively obtained at the network node, each analog signal of the first set of analog signals indicating the positive gradient value, and the second aggregated analog signal obtained in the second RE represents a second set of analog signals accumulatively obtained at the network node, each analog signal of the second set of analog signals indicating the negative gradient value.

Aspect 19 is the method of aspect 18, further including comparing a first magnitude of the first aggregated analog signal obtained in the first RE and a second magnitude of the second aggregated analog signal obtained in the second RE, where the parameter is updated based on a comparison of the first magnitude and the second magnitude.

Aspect 20 is the method of aspect 19, further including generating an aggregated gradient of the parameter based on the comparison of the first magnitude and the second magnitude, where the parameter is updated based on the aggregated gradient of the parameter.

Aspect 21 is the method of any of aspects 19 and 20, where the aggregated gradient of the parameter has a value of +p based on the first magnitude being greater than the second magnitude, the aggregated gradient of the parameter has a value of −p based on the first magnitude being smaller than or equal to the second magnitude, and the p being a real number.

Aspect 22 is the method of any of aspects 17 to 21, further including outputting for transmission an information associated with the updated parameter of the machine learning model to plurality of UEs.

Aspect 23 is the method of aspect 22, where the information associated with the updated parameter includes the updated parameter.

Aspect 24 is the method of any of aspects 17 to 23, further including outputting for transmission an indication of the pair of REs for the plurality of UEs, where the at least one aggregated analog signal is obtained in the pair of REs based on the indication of the pair of REs.

Aspect 25 is an apparatus for wireless communication including at least one processor coupled to a memory and configured to implement any of aspects 17 to 24, further including a transceiver coupled to the at least one processor.

Aspect 26 is an apparatus for wireless communication including means for implementing any of aspects 17 to 24.

Aspect 27 is a non-transitory computer-readable medium storing computer executable code, where the code when executed by a processor causes the processor to implement any of aspects 17 to 24.

Aspect 28 is a method of wireless communication at a network node, including outputting for transmission parameters of a machine learning model for a plurality of UEs, obtaining an aggregated analog signal in a single RE designated for the plurality of UEs to indicate a sign of a gradient value relative to a parameter of the parameters of the machine learning model of the plurality of UEs, the aggregated analog signal obtained in the single RE representing a plurality of analog signals accumulatively obtained from the plurality of UEs at the network node, each analog signal of the plurality of analog signals indicating that the sign of the gradient value relative to the parameter of the parameters of the machine learning model calculated at corresponding UE of the plurality of UEs is one of positive or negative, and updating the parameter of the parameters of the machine learning model based on the aggregated analog signal obtained in the single RE.

Aspect 29 is the method of aspect 28, where a presence of the analog signal in the single RE indicates that the sign of the gradient value is, and an absence of the analog signal in the single RE indicates that the sign of the gradient value is negative.

Aspect 30 is the method of any of aspects 28 and 29, further including comparing a magnitude of the aggregated analog signal obtained in the single RE and a threshold value, where the parameter is updated based on a comparison of the magnitude and the threshold value.

Aspect 31 is the method of aspect 30, further including generating an aggregated gradient of the parameter based on the comparison of the magnitude and the threshold value, where the parameter is updated based on the aggregated gradient of the parameter.

Aspect 32 is the method of aspect 31, where the aggregated gradient of the parameter has a value of +p based on the magnitude being greater than the threshold value, the aggregated gradient of the parameter has a value of −p based on the magnitude being smaller than or equal to the threshold value, and the p being a real number.

Aspect 33 is the method of any of aspects 28 to 32, further including outputting for transmission an information associated with the updated parameter of the machine learning model to plurality of UEs.

Aspect 34 is the method of aspect 33, where the information associated with the updated parameter includes the updated parameter.

Aspect 35 is the method of any of aspects 28 to 34, further including outputting for transmission an indication of the single RE for the plurality of UEs, where the at least one aggregated analog signal is obtained in the single RE based on the indication of the single RE.

Aspect 36 is an apparatus for wireless communication including at least one processor coupled to a memory and configured to implement any of aspects 28 to 35, further including a transceiver coupled to the at least one processor.

Aspect 37 is an apparatus for wireless communication including means for implementing any of aspects 28 to 35.

Aspect 38 is a non-transitory computer-readable medium storing computer executable code, where the code when executed by a processor causes the processor to implement any of aspects 28 to 35.

What is claimed is:

1. An apparatus for wireless communication at a user equipment (UE), comprising:
a memory; and
at least one processor coupled to the memory and configured to:
receive parameters of a machine learning model from a network node;
calculate a gradient value relative to a parameter of the parameters of the machine learning model, the gradient value including a positive gradient value or a negative gradient value; and
transmit, in one resource element (RE) of a pair of REs to the network node, an analog signal indicating a magnitude of the gradient value relative to the parameter of the parameters of the machine learning model, the pair of REs designated for indicating the gradient value relative to the parameter of the parameters of the machine learning model.

2. The apparatus of claim 1, wherein the pair of REs designated for indicating the parameters of the machine learning model includes:
a first RE designated for indicating the positive gradient value; and
a second RE designated for indicating the negative gradient value,
wherein the analog signal is transmitted in the first RE or the second RE based on the gradient value.

3. The apparatus of claim 1, wherein the at least one processor is further configured to:
receive information associated with an updated parameter of the machine learning model from the network node, the updated parameter based at least in part on the analog signal transmitted to the network node; and
update the parameter of the machine learning model based on the information associated with the updated parameter received from the network node.

4. The apparatus of claim 3, wherein the information associated with the updated parameter includes the updated parameter based at least in part on the analog signal transmitted to the network node.

5. The apparatus of claim 1, wherein the at least one processor is further configured to receive an indication of the pair of REs from the network node, and
wherein the analog signal is transmitted in the one RE of the pair of REs based on the indication of the pair of REs received from the network node.

6. The apparatus of claim 1, further comprising a transceiver coupled to the at least one processor and configured to transmit the analog signal.

7. An apparatus for wireless communication at a user equipment (UE), comprising:
a memory; and
at least one processor coupled to the memory and configured to:
receive parameters of a machine learning model from a network node;
calculate a gradient value relative to a parameter of the parameters of the machine learning model, a sign of the gradient value being one of positive or negative; and
transmit or skip transmission of, in a single resource element (RE) to the network node, an analog signal based on the sign of the gradient value relative to the parameter of the parameters of the machine learning model, the single RE designated for indicating the sign of the gradient value relative to the parameter of the parameters of the machine learning model.

8. The apparatus of claim 7, wherein a presence of the analog signal in the single RE indicates that the sign of the gradient value is positive, and an absence of the analog signal in the RE indicates that the sign of the gradient value is negative.

9. The apparatus of claim 7, wherein the at least one processor is further configured to:
receive information associated with an updated parameter of the machine learning model from the network node, the updated parameter based at least in part on the analog signal transmitted to the network node; and
update the parameter of the machine learning model based on the information associated with the updated parameter received from the network node.

10. The apparatus of claim 9, wherein the information associated with the updated parameter includes the updated parameter based at least in part on the analog signal transmitted to the network node.

11. The apparatus of claim 7, wherein the at least one processor is further configured to receive an indication of the single RE from the network node,
wherein the analog signal is transmitted in the single RE based on the indication of the single RE received from the network node.

12. The apparatus of claim 7, further comprising a transceiver coupled to the at least one processor and configured to transmit the analog signal.

13. An apparatus for wireless communication at a network node, comprising:
a memory; and
at least one processor coupled to the memory and configured to:
output for transmission parameters of a machine learning model for a plurality of user equipments (UEs);
obtain at least one aggregated analog signal in a pair of resource elements (REs) designated for the plurality of UEs to indicate a gradient value relative to a parameter of the parameters of the machine learning model of the plurality of UEs, the at least one aggregated analog signal obtained in the pair of REs representing a plurality of analog signals accumulatively obtained from the plurality of UEs at the network node, each analog signal of the plurality of analog signals indicating the gradient value relative to the parameter of the parameters of the machine learning model calculated at corresponding UE of the plurality of UEs, the gradient value including a positive gradient value or a negative gradient value; and
update the parameter of the parameters of the machine learning model based on the at least one aggregated analog signal obtained in the pair of REs.

14. The apparatus of claim 13, wherein the at least one aggregated analog signal includes a first aggregated analog signal and a second aggregated analog signal, and the pair of REs designated for indicating the parameter of the parameters of the machine learning model includes a first RE and a second RE,
wherein the first aggregated analog signal obtained in the first RE represents a first set of analog signals accumulatively obtained at the network node, each analog signal of the first set of analog signals indicating the positive gradient value, and
wherein the second aggregated analog signal obtained in the second RE represents a second set of analog signals accumulatively obtained at the network node, each analog signal of the second set of analog signals indicating the negative gradient value.

15. The apparatus of claim 14, wherein, the at least one processor is further configured to compare a first magnitude of the first aggregated analog signal obtained in the first RE and a second magnitude of the second aggregated analog signal obtained in the second RE, and
wherein the parameter is updated based on a comparison of the first magnitude and the second magnitude.

16. The apparatus of claim 15, wherein the at least one processor is further configured to generate an aggregated gradient of the parameter based on the comparison of the first magnitude and the second magnitude,
wherein the parameter is updated based on the aggregated gradient of the parameter.

17. The apparatus of claim 15, wherein the aggregated gradient of the parameter has a value of +p based on the first magnitude being greater than the second magnitude,
wherein the aggregated gradient of the parameter has a value of −p based on the first magnitude being smaller than or equal to the second magnitude, and
wherein the p being a real number.

18. The apparatus of claim 13, wherein the at least one processor is further configured to:
output for transmission information associated with the updated parameter of the machine learning model to plurality of UEs.

19. The apparatus of claim 18, wherein the information associated with the updated parameter includes the updated parameter.

20. The apparatus of claim 13, wherein the at least one processor is further configured to output for transmission an indication of the pair of REs for the plurality of UEs, and wherein the at least one aggregated analog signal is obtained in the pair of REs based on the indication of the pair of REs.

21. The apparatus of claim 13, further comprising a transceiver coupled to the at least one processor and configured to obtain the aggregated analog signal.

22. An apparatus for wireless communication at a network node, comprising:
a memory; and
at least one processor coupled to the memory and configured to:
output for transmission parameters of a machine learning model for a plurality of user equipments (UEs);
obtain an aggregated analog signal in a single resource element (RE) designated for the plurality of UEs to indicate a sign of a gradient value relative to a parameter of the parameters of the machine learning model of the plurality of UEs, the aggregated analog signal obtained in the single RE representing a plurality of analog signals accumulatively obtained from the plurality of UEs at the network node, each analog signal of the plurality of analog signals indicating that the sign of the gradient value relative to the parameter of the parameters of the machine learning model calculated at corresponding UE of the plurality of UEs is one of positive or negative; and
update the parameter of the parameters of the machine learning model based on the aggregated analog signal obtained in the single RE.

23. The apparatus of claim 22, wherein a presence of the analog signal in the single RE indicates that the sign of the gradient value is, and an absence of the analog signal in the single RE indicates that the sign of the gradient value is negative.

24. The apparatus of claim 22, wherein, the at least one processor is further configured to compare a magnitude of the aggregated analog signal obtained in the single RE and a threshold value, and
wherein the parameter is updated based on a comparison of the magnitude and the threshold value.

25. The apparatus of claim 24, wherein the at least one processor is further configured to generate an aggregated gradient of the parameter based on the comparison of the magnitude and the threshold value,
wherein the parameter is updated based on the aggregated gradient of the parameter.

26. The apparatus of claim 25, wherein the aggregated gradient of the parameter has a value of +p based on the magnitude being greater than the threshold value,
wherein the aggregated gradient of the parameter has a value of −p based on the magnitude being smaller than or equal to the threshold value, and
wherein the p being a real number.

27. The apparatus of claim 22, wherein the at least one processor is further configured to:
output for transmission information associated with the updated parameter of the machine learning model to plurality of UEs.

28. The apparatus of claim 27, wherein the information associated with the updated parameter includes the updated parameter.

29. The apparatus of claim 22, wherein the at least one processor is further configured to output for transmission an indication of the single RE for the plurality of UEs, and
wherein the at least one aggregated analog signal is obtained in the single RE based on the indication of the single RE.

30. The apparatus of claim 22, further comprising a transceiver coupled to the at least one processor and configured to obtain the aggregated analog signal.
